(19) United States
(12) Patent Application Publication
(10) Pub. No.: US 2026/0277939 A1
(43) Pub. Date: Sep. 17, 2026

(54) GENERATING INSIGHTS FOR SOFTWARE APPLICATIONS AND ROUTING CUSTOMIZED RECOMMENDATIONS FOR TARGET ENTITIES

(71) Applicant: Citibank, N.A., New York, NY (US)

(72) Inventors: Katie Dilaj, London (GB); Rama Krishna Inampudi, Irving, TX (US); Himanshu Gulati, Irving, TX (US); Anjali Kaushal, Irving, TX (US); Richard Lawton, Irving, TX (US); Girish Wali, Irving, TX (US); David Anandaraj Arulraj, Mason, OH (US); Deepali Tuteja, Irving, TX (US)

(21) Appl. No.: 19/669,640

(22) Filed: May 6, 2026

Related U.S. Application Data
(63) Continuation-in-part of application No. 19/247,219, filed on Jun. 24, 2025.
Application No. 19/247,219 is a continuation-in-part of application No. 19/215,019, filed on May 21, 2025, now Pat. No. 12,411,873.
Application No. 19/215,019 is a continuation of application No. 18/123,179, filed on Mar. 17, 2023, now Pat. No. 12,314,289.
(60) Provisional application No. 63/801,020, filed on May 6, 2025.
(60) Provisional application No. 64/031,221, filed on Apr. 6, 2026.

(51) Int. Cl. G06F 16/28; G06F 16/21; G06F 16/25

(52) U.S. Cl. CPC G06F 16/287; G06F 16/213; G06F 16/258

(57) ABSTRACT

One or more configurations associated with a plurality of software applications within a distributed computing infrastructure are obtained. Data associated with a plurality of software applications operating within a distributed computing infrastructure is obtained. First resource data is received from data sources and second resource data is generated in a format different from the first resource data. The second resource data is integrated into a data source using one or more configurations associated with the software applications. An indication of data points corresponding to the second resource data is received. Information identifying a target entity is obtained from the indication or metadata associated with the target entity. A recommendation object generated from a portion of the second resource data is determined.

### CROSS-REFERENCE TO RELATED APPLICATION

This application is a continuation-in-part of co-pending U.S. application Ser. No. 19/247,219, (Attorney Docket No. 0061257-016US0) filed on Jun. 24, 2025, entitled “GENERATING INSIGHTS FOR SOFTWARE APPLICATIONS,” which is a continuation-in-part of co-pending U.S. patent application Ser. No. 19/215,019, filed on May 21, 2025, entitled “AGGREGATING DATA INGESTED FROM DISPARATE SOURCES FOR PROCESSING USING MACHINE LEARNING MODELS,” issued as U.S. Pat. No. 12,411,873 dated Sep. 9, 2025, which is a continuation of U.S. patent application Ser. No. 18/123,179, filed on Mar. 17, 2023, now issued as U.S. Pat. No. 12,314,289, and dated May 27, 2025, entitled “AGGREGATING DATA INGESTED FROM DISPARATE SOURCES FOR PROCESSING USING MACHINE LEARNING MODELS,” the full disclosures of which are incorporated by reference herein in their entireties. This application further claims the benefit of U.S. Provisional Application No. 63/801,020 (Attorney Docket No. 0061257-017PR0), filed on May 6, 2025, and U.S. Provisional Application No. 64/031,221 (Attorney Docket No. 0061257-017PR1) filed on Apr. 6, 2026, each entitled “ARTIFICIAL INTELLIGENCE MODELS TO GENERATE CUSTOMIZED DATA,” the full disclosures of which are incorporated by reference herein in their entireties.

### BACKGROUND

In a computer-networked environment, processes, applications, and services executing in a distributed manner across servers and devices may generate vast amounts of data, which is then stored among multiple databases, each modified to specific functions and organized according to its own standards. This fragmented storage approach can make it difficult for technology stakeholders to gain a unified view of operations, as they may need to access each database individually, leading to limited visibility and challenges in identifying performance issues across the network. The problem may be further compounded by the sheer volume of data and lack of integration between databases, which can prevent timely diagnosis and resolution of issues affecting applications or services. Additionally, critical information about software usage, performance, and cost may be dispersed in inconsistent formats across these isolated systems, making it difficult to assess whether software should be discontinued, replaced, or enhanced. As a result, generating reports, aggregating metrics, and comparing enterprise applications may become manual, error-prone tasks that limit decision-making and reduce the overall value of the data. In many enterprise environments, these challenges are further exacerbated because end users operate primarily within workflow systems, such as enterprise resource planning (ERP) systems, treasury management systems (TMS), transportation management systems that may be part of supply chain management systems, or other systems of record, and are therefore forced to leave such workflow systems to identify relevant insights. Even where dashboards or analytics are available, users may still be unable to determine which displayed insights are relevant to another entity, such as a manager, analyst, delegate, or business owner, or whether a displayed insight should be routed to that other entity. In addition, if a recommendation or notification is routed to another entity, the recipient may be unable to determine why the recommendation was selected, which displayed insight or underlying data supports the recommendation, or whether the recommendation is being presented automatically or on behalf of another entity.

### SUMMARY

Disclosed herein are systems and methods for aggregating data from disparate sources to process and output information using machine learning (ML) models. Through a network environment (e.g., an enterprise including data center, branch offices, and remote users), end-users on client devices may access applications hosted on a multitude of servers. In this environment, the processes of one application may affect or be related to the processes of other applications within the network. In connection with running processes of the applications, the servers may produce vast quantities of data. The servers may provide the produced data for storage across a variety of databases. Even for a single application, the servers may store the data on different databases depending on the type of operation carried out for the application. Each database may store and maintain the data in accordance with its own different or disparate specifications, such as those for arrangement, formatting, and content, among others.

A user may view the data from these databases for further analysis and diagnosis in an attempt to gain insight into the operations of the applications or servers across the network environment. Because the data for a particular application or set of processes is stored in different databases, the user may have to resort to accessing individual databases to retrieve the data maintained therein. For instance, a network administrator may have to access a specific server for a certain application to obtain performance-related metrics for the application. Expanding this to metrics for applications accessible through the network, the user may have to manually retrieve the data from a myriad of databases associated with different operations or applications.

As a consequence, it may be very difficult for the user to gather holistic information across multiple applications or servers within the network environment (e.g., across an enterprise), resulting in the user having to spend enormous tedious and manual efforts to fetch the data from different databases. Even when the data is collected, the data may not be ready for immediate use, because the retrieved data may be stored in a different manner using particular formatting and specifics. Due to the inability to access data across multiple databases, any issues or problems affecting performance across multiple applications or servers within the network may remain undetected or unresolved. These issues may be exacerbated by the fact that while processes of one application may affect the processes of another or the same application, the data stored across multiple databases may not reflect these relationships.

To address these and other technical problems, a service may aggregate data from multiple data sources of the network environment using machine learning (ML) models in order to output information. The server may establish and maintain a set of ML models to provide various outputs regarding the data of the environment, such as application function, application deployment, risk assessment, or key performance indicators, among others. The ML models may include models trained in accordance with supervised learning (e.g., an artificial neural network (ANN), decision tree, regression model, Bayesian classifier, or support vector machine (SVM)) and models trained in accordance with unsupervised learning (e.g., clustering models), among others.

The service may access multiple databases to ingest the data therein over a sampling period. With the aggregation of the data, the service may transform the data for input into one of the ML models. As part of the transformation, the service may convert the formatting of the data from the original of the data source to a formatting compatible for inputting into one the ML models. The service may also automatically perform correction and augmentation of the data from other sources. The service may generate category tags for each piece of data based on the contents therein, with each category tag for one or more of the ML models. The service may group or segment the data by category tags for storage prior to input. The groups of data may be from multiple data sources and in a format compatible for input into one of the ML models maintained by the service.

For a given group of transformed data, the service may select a ML model from the set to apply. The selection may be based on the category tag associated with the group. For instance, the service may maintain one ML model to process application data (e.g., with application process category tags) and another ML model to process data (e.g., with transaction category tags). With the selection, the service may feed the group of data as input into the ML model and process the data in accordance with the weights of the ML model to produce an output. Under learning mode, the service may use the output to further train the ML model, for example, by updating the weights of the model using a loss between the produced output and the expected output. The service may use data from previous sampling periods as part of training and validation to refine the ML model.

Under runtime mode, the service may generate a visualization of the output from the ML model using a template for the type of output. The template may define the visualization of information as identified in the output from the ML model for fast and easy comprehension by the user viewing the visualization. The visualization may be in the form of a bar graph, pie chart, histogram, or Venn diagram, other graphic for presenting insights and analytics for various operations and applications in the network environment. With the visualizations, the user may be able quickly assess and pinpoint any problems or potential risks affecting the performance of applications or processes on servers across the network.

In this manner, the service may provide for an automated data analysis to reduce the amount of time and effort spent by users in attempting to manually track down, fetch, and evaluate data. Since the data originally stored across multiple databases can be retrieved, transformed, and processed by the service to provide outputs regarding the data, any issues with applications or processes whose data is stored across these databases can now be detected. Combined with the visualization of the output from the ML models using templates, a user may be able to readily and quickly assess any such problems or risks in the network. Furthermore, with the use of data from prior sampling periods to train and update the ML models, the service may be able to provide more accurate and refined outputs for the data retrieved from these sources. As such, problems or risks affecting the performance of applications or processes on servers across the network (e.g., across an enterprise) may be pinpointed and addressed. This may also improve the overall performance of the servers and client devices in the network, for instance, by reducing the computer and network resources tied up due to previously undetectable issues.

Aspects of present disclosure are directed to systems, methods, and non-transitory computer readable media for aggregating data from disparate sources to output information. A computer system may maintain a plurality of machine learning (ML) models configured for evaluating a plurality of feature. The computing system may transform a first plurality of datasets of a plurality of data sources over a first time period by converting a first format of the corresponding data source for each of the first plurality of datasets to generate a second plurality of datasets in a second format of the computing system and configured for input to one of the plurality of ML models. The computing system may identify from the second plurality of datasets, a subset of datasets using a feature selected from the plurality of features for evaluation of a utility of the feature. The computing system may apply an ML model of the plurality of ML models configured for the selected feature to the subset of datasets to generate an output that measures a likelihood of usefulness. The ML model may be trained using a third plurality of datasets for the feature from the plurality of data sources over a second time period. The computing system may cause a visualization of the output for the feature to be displayed for presentation on a dashboard interface based on a template configured for the feature.

In one embodiment, the computing system may receive, via the dashboard interface, a selection of a plurality of categories for the plurality of features to be evaluated. The computing system may generate a tag identifying a category of the plurality of categories for each dataset of the second plurality of datasets. The computing system may identify the subset of datasets using the tag identifying the category of each dataset of the second plurality of datasets.

In another embodiment, the computing system may determine that more data is to be added to the subset of datasets for evaluating the utility of the feature. The computing system may retrieve a second subset of data from the second plurality of datasets to supplement the subset of datasets.

In yet another embodiment, the computing system may retrieve a fourth plurality of datasets from the plurality of data sources over a third time period. The computing system may identify a subset of ML models from the plurality of ML models corresponding to a subset of features from the plurality of features present in the fourth plurality of datasets. The computing system may re-train the subset of the plurality of ML models using the fourth plurality of datasets.

In yet another embodiment, the computing system may generate from the second plurality of datasets a plurality of subsets of data corresponding to the plurality of ML models for evaluating the corresponding plurality of features. The computing system may identify the subset from the plurality of subsets based on the feature selected from the plurality of features.

In yet another embodiment, the computing system may receive, via the dashboard interface, a selection of the feature from the plurality of features to be evaluated for utility. The computing system may select, from the plurality of ML models, the ML model to be applied to the subset of datasets based on the selection of the feature.

In yet another embodiment, the computing system may retrieve the first plurality of datasets from the plurality of data sources for one or more applications over the first time period. Each of the first plurality of datasets may identify at least one of a function type, a usage metric, a security risk factor, or a system criticality measure. The computing system may identify, from the second plurality of datasets transformed from the first plurality of datasets, a second subset of datasets and a third subset of datasets for evaluation of an application of the one or more applications. The computing system may train the ML model configured for evaluating the one or more applications using the second subset of dataset. The computing system may validate the ML model using the third subset of datasets.

In yet another embodiment, the computing system may apply the ML model to the subset of datasets to generate the output to identify whether the application is deprecated from use. The computing system may cause the visualization of the output for the identification of whether application is deprecated. In yet another embodiment, the computing system may maintain the plurality of ML models comprising a first subset of ML models trained in accordance with supervised learning and a second subset of ML models trained in accordance with unsupervised learning. In yet another embodiment, the computing system may identify, from a plurality of templates corresponding to the plurality of features, a template corresponding to the feature to use for generating the visualization of the output.

According to one example of the present application, a system can be configured to perform particular operations or actions by virtue of having software, firmware, hardware, or a combination of them installed on the system that in operation causes or cause the system to perform the actions. For example, the system can perform a computer-implemented method that includes receiving software application metadata corresponding to a plurality of software applications installed throughout a distributed computing infrastructure. The computer-implemented method may include receiving a function indicative of a mapping of related software applications of the plurality of software applications. The computer-implemented method may include receiving from a plurality of data sources in the distributed computing infrastructure, resource usage data corresponding to the plurality of software applications. The computer-implemented method may include transforming a plurality of different data formats of the resource usage data into normalized data in a standardized format. The computer-implemented method may include consolidating the normalized data into a unified data source using the mapping and the software application metadata. The computer-implemented method may include receiving, from a graphical user interface (GUI) dashboard, a request to transform at least a portion of the normalized data according to one or more data points. The computer-implemented method may include in response to the request: transforming at least the portion of the normalized data into transformed data and sending the transformed data for display at the GUI dashboard. Other embodiments of this aspect may include corresponding computer systems, apparatus, and computer programs recorded on one or more computer storage devices, each configured to perform the actions of the methods.

In some embodiments, the computing system may determine, from among a plurality of displayed insights generated from normalized data, one or more insight objects that are relevant to a target entity based at least in part on metadata corresponding to the target entity. The metadata may include one or more of a role, title, organizational responsibility, geography, watchlist, preference, threshold, watchlist, priority, historical interaction, workflow responsibility, delegated authority, or other profile information associated with the target entity. The computing system may rank or score the plurality of displayed insights based on the metadata to select one or more insight objects for presentation, routing, summarization, or recommendation generation.

In some embodiments, the computing system may obtain, from a first computing device, a query or instruction associated with a target entity and may, in response, identify a portion of normalized data, a transformed portion of data, a displayed insight object, or a recommendation object corresponding to the target entity. The computing system may present the identified portion, displayed insight object, or recommendation object to the first computing device, obtain a confirmation, endorsement, or routing instruction from the first computing device, and provide the identified portion, a modified version thereof, a summary thereof, or the recommendation object to a second computing device associated with the target entity.

In some embodiments, the computing system may generate a recommendation object or notification based on transformed enterprise data. The recommendation object or notification may identify a projected condition, forecast event, threshold breach, upcoming obligation, imbalance, or anomaly, and may further identify a proposed action responsive thereto, including without limitation a transfer, allocation, escalation, coverage action, or other next-best action. The recommendation object or notification may be transmitted to a target entity directly, displayed in an interface embedded within an ERP, TMS, or other workflow application, and/or delivered on behalf of an originating entity.

In some embodiments, the computing system may associate a displayed insight object, transformed portion of data, notification, or recommendation object with provenance metadata and one or more workflow states. The provenance metadata may identify an originating entity, an endorsing entity, a time, a source interface, or an “on behalf of” designation. The workflow states may include one or more of suggested, selected, awaiting confirmation, sent, delivered, viewed, acknowledged, completed, dismissed, acted upon, or the like. The computing system may further provide an explanation or drill-down affordance that identifies supporting data, one or more underlying dashboard views, a rationale summary, a transformed portion of data, a notification, and/or a confidence value associated with the displayed insight object or recommendation object.

Implementations may include one or more of the following features: The computer-implemented method where transforming the plurality of different data formats further may include integrating the resource usage data based, at least in part, on individual data formats of the plurality of different data formats; and generating additional resource usage data that corresponds to the distributed computing infrastructure based, at least in part, on the integrated resource usage data. The computer-implemented method may include receiving an identifier of a software application of the plurality of software applications within the distributed computing infrastructure, the identifier may include a name or a number associated with the software application; and determining a portion of the normalized data based, at least in part, on the identifier. The software application metadata, the function, and the resource usage data can be from different data sources that are distinct from the unified data source. Implementations of the described techniques may include hardware, a method or process, or computer software on a computer-accessible medium.

The system can include one or more processors. The system can include one or more non-transitory, computer-readable media may include executable instructions recorded thereon that, as a result of execution by the one or more processors, cause the system to at least: obtain one or more configurations associated with a plurality of software applications within a distributed computing infrastructure; receive, from a plurality of data sources in the distributed computing infrastructure, first resource data associated with the plurality of software applications; generate second resource data in a standardized format from different data formats of the first resource data; integrate the second resource data into a data source using the one or more configurations; and in response to an indication of one or more data points corresponding to the second resource data, transform one or more portions of the second resource data. In some embodiments, the computing system may receive an indication of one or more data points corresponding to the second resource data. The indication may be received from a computing device, a data repository, a database, a data storage system, an application programming interface (API), or another system component configured to access the second resource data. In some examples, the indication may correspond to a request, query, instruction, or message that references one or more data points corresponding to the second resource data for processing, transformation, analysis, or retrieval by the computing system.

Additionally, the executable instructions can further include instructions that further cause the system to provide the one or more transformed portions of the second resource data for display at a dashboard. The second resource data may include total resource usage data of the distributed computing infrastructure. The executable instructions can further include instructions that further cause the system to: obtain an indication of a software application of the plurality of software applications within the distributed computing infrastructure; and determine a portion of the second resource data based, at least in part, on the indication. The executable instructions that cause the system to transform one or more portions of the second resource data can further include instructions that further cause the system to transform the one or more portions to match a data format specified by a user request. The indication of the one or more data points can be obtained as a result of interaction with one or more elements of a GUI. The executable instructions can further include instructions that further cause the system to generate instructions for at least a portion of the distributed computing infrastructure based, at least in part, on the second resource data. The one or more configurations can correspond to a function that is to be performed by executing at least one of the plurality of software applications within the distributed computing infrastructure. Implementations of the described techniques may include hardware, a method or process, or computer software on a computer-accessible medium.

The one or more non-transitory computer-readable storage media can store computer-executable instructions that cause the system obtain software application metadata corresponding to a plurality of software applications installed throughout a distributed computing infrastructure. The computer-executable instructions can cause the system to obtain one or more configurations of related software applications of the plurality of software applications. The computer-executable instructions can cause the system to obtain, from a plurality of data sources in the distributed computing infrastructure, resource data corresponding to the plurality of software applications. The computer-executable instructions can cause the system to transform a plurality of different data formats of the resource data into additional data in a standardized format. The computer-executable instructions can cause the system to also includes integrate the additional data into a unified data source using the one or more configurations. The computer-executable instructions can cause the system to obtain a request to transform one or more portions of the additional data. The computer-executable instructions can cause the system to provide the one or more portions that are transformed.

Additionally, computer-executable instructions can cause the system to obtain an indication of a software application of the plurality of software applications within the distributed computing infrastructure; and determine a portion of the additional data based, at least in part, on the indication. The request can be obtained based, at least in part, on one or more interactions with one or more GUI elements. The one or more configurations and the resource data can be from different data sources. The additional data may include total resource usage data of the distributed computing infrastructure. The request may include one or more parameters to indicate the one or more portions of the distributed computing infrastructure. The one or more configurations can correspond to one or more functions to be performed by executing at least one of the plurality of software applications within the distributed computing infrastructure. The one or more configurations can be generated based, at least in part, on a hierarchy between two or more functions associated with the plurality of software applications within the distributed computing infrastructure.

It is to be understood that both the foregoing general description and the following detailed description are exemplary and explanatory and are intended to provide further explanation of the embodiments described herein.

### BRIEF DESCRIPTION OF THE DRAWINGS

The accompanying drawings constitute a part of this specification, illustrate an embodiment, and together with the specification, explain the subject matter of the disclosure. Various techniques will be described with reference to the drawings, in which:

FIG. 1 depicts a block diagram of a platform for aggregating and visualizing data from disparate sources in accordance with an illustrative embodiment;

FIG. 2 depicts a block diagram of a system for aggregating data from disparate sources to output information using machine learning (ML) models in accordance with an illustrative embodiment;

FIG. 3 depicts a block diagram of a system for aggregating data from disparate sources in accordance with an illustrative embodiment;

FIG. 4 depicts a block diagram of a system for training ML models using aggregated data in accordance with an illustrative embodiment;

FIG. 5 depicts a block diagram of a system for processing aggregated data using ML models for output in accordance with an illustrative embodiment;

FIG. 6 depicts a flow diagram of a method of aggregating data from disparate sources to output information using ML models in accordance with an illustrative embodiment;

FIGS. 7A-C depict screenshots of information on processes and application mapping presented on a dashboard interface in accordance with an illustrative embodiment;

FIGS. 8A-C depict screenshots of information characterizing applications generated presented on a dashboard interface in accordance with an illustrative embodiment;

FIGS. 9A-E depict screenshots of information of risk factors from application processes presented on a dashboard interface in accordance with an illustrative embodiment;

FIGS. 10A-D depict a flow diagram of a use case for aggregate data related to applications and outputting information on application commission using machine learning (ML) models in accordance with an illustrative embodiment;

FIG. 11 illustrates an example system to generate insights for software applications, in accordance with an embodiment;

FIG. 12 illustrates an example dashboard to provide insights, in accordance with an embodiment;

FIG. 13 illustrates an example dashboard to provide insights related to resource usage, in accordance with an embodiment;

FIG. 14 illustrates an example dashboard to provide insights related to functions to map software applications, in accordance with an embodiment;

FIG. 15 illustrates an example interface that may display one or more insight objects generated from normalized data, in accordance with an embodiment;

FIG. 16 illustrates a process performed by one or more processors to determine and route one or more insight objects that are relevant to a target entity, in accordance with an embodiment;

FIG. 17 illustrates an example interface in which one or more processors present a routed insight or recommendation interaction associated with a target entity, in accordance with an embodiment;

FIG. 18 illustrates an example flowchart of generating insights, in accordance with an embodiment;

FIG. 19 illustrates another flowchart of an example of aggregating resource usage data to generate insights, in accordance with at least one embodiment; and

FIG. 20 illustrates an example system to generate interactive insights of software applications using application programming interface (API), in accordance with at least one embodiment.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, as well as additional applications of the principles as illustrated here, which would occur to a person skilled in the relevant art and having possession of this disclosure, are to be considered within the scope of the disclosure.

The present disclosure is directed to systems and methods for aggregating data from multiple data sources of the network environment to output information using ML models. The server may establish and maintain a set of ML models to provide various outputs regarding the data of the environment. The service may access multiple databases to perform ingestion of the data therein over a sampling period for the applications and processes of the network environment. With the aggregation of the data, the service may transform the data to make the data compatible for input into one of the ML models. For a given group of transformed data, the service may select a ML model from the set to apply. With the selection, the service may feed the group of data as input into the ML model and process the data in accordance with the weights of the ML model to produce an output. Under runtime mode, the service may generate a visualization of the output from the ML model using a template for the type of output. The visualization may be used to present insights and analytics for various operations and applications in the network environment.

In some examples, the systems can consolidate various types of data from multiple sources and provide a graphical user interface (GUI) with a customizable, comprehensive view of application systems, technology products, and enterprise process taxonomies within an entity. The systems can automate data collection from distributed systems into an aggregated data structure and provide the GUI as a one-stop dashboard allowing users to quickly analyze key metrics and make informed decisions about budget management, resource allocation, and risk strategies.

In some embodiments, the systems described herein may be embedded within, launched from, or otherwise integrated with an enterprise workflow application, such as an enterprise resource planning (ERP) system, a transportation management system, a supply chain management system, treasury management system (TMS), financial operations platform, enterprise portal, or other system of record. For example, one or more dashboard views, transformed data presentations or other media, conversational interfaces, and routed notifications described herein may be rendered within a user interface of the workflow application so that an entity can view, request, confirm, or route one or more insight objects without leaving the workflow application. Such embedding can reduce context switching, improve adoption, and cause transformed data, recommendation objects, and notifications to be surfaced in the flow of work.

In different examples, the systems can collect and consolidate diverse types of data related to software applications deployed within a distributed computing infrastructure. The systems can receive process taxonomy data—such as classifications and hierarchies of running processes—as well as software application attributes, including versioning, configurations, performance metrics, and usage patterns. The systems can interface with various nodes or monitoring agents across the infrastructure to retrieve this information in real-time or at scheduled intervals.

In various examples, the systems can normalize and structure heterogeneous data sets related to software applications deployed across a distributed computing infrastructure. The systems can be configured to receive disparate data sources, such as tables containing application attributes, usage metrics, and configuration parameters, and consolidate these into a unified schema. The systems can generate a single, normalized table by aligning and joining multiple input tables based on a common data point, such as a software application identifier. The systems can use process taxonomy data to categorize and map software applications to other software applications or related information (e.g., metadata, resource information), thereby enabling a structured representation of application relationships and hierarchies.

The systems can present, via a GUI, normalized and combined data regarding various software applications deployed within a distributed computing infrastructure. As a result, the GUI can provide a holistic view of the entire infrastructure, enabling users to perform a cost-benefit analysis of not only individual software applications but also multiple applications collectively. The GUI can also offer various visual representations of the normalized data, along with interactive features that allow users to obtain a more detailed view of specific data points. The GUI can provide customized data based on user requests, where the request may include one or more parameters (e.g., software application identifier) to filter the normalized data. Additionally, the GUI can display graphs to illustrate historical trends or any time series data related to the software applications.

In some embodiments, the normalized and combined data can be used to generate one or more displayed insight objects, such as dashboard cards, metrics, charts, tiles, alerts, summaries, or recommendations. An entity interacting with the GUI may select one or more displayed insight objects for evaluation with respect to another entity. In at least one embodiment, an entity is an AI agent that identifies insight objects from an available database rather than a GUI. The system may retrieve or generate a priority profile associated with the other entity and may score the displayed insight objects according to the priority profile to identify which displayed insight objects are likely to be relevant to that other entity. The priority profile may be based on role, geography, organizational ownership, line of business, thresholds, goals, historical interactions, preferences, permissions, or delegated responsibilities.

In some embodiments, an insight object comprises a graphical or textual user interface element generated by one or more processors from normalized or transformed enterprise data. The insight object may correspond to a dashboard card, chart, metric tile, alert panel, summary panel, or other visual component rendered within a graphical user interface. Each insight object may include data attributes identifying a data source, category tag, timestamp, confidence value, or supporting transformed data elements used to generate the insight object.

In some embodiments, a priority profile is generated from explicit input, inferred behavior, or stored metadata. For example, the system may infer that a first entity is likely to prioritize liquidity, forecast exceptions, vendor obligations, regional spending, or other categories of displayed insight objects based on prior interactions with the GUI, prior routing decisions, threshold subscriptions, such as subscriptions to alerts triggered when monitored metrics cross predefined limits, workflow activities, workflow decisions, or workflow responsibilities. In this manner, the system can determine which displayed insight objects should be surfaced, summarized, or routed for that first entity even when the first entity did not originate the request. In some embodiments, the prior interactions, prior routing decisions, threshold subscriptions, workflow activities, workflow decisions, or workflow responsibilities are constantly, periodically (e.g., at a preset cadence), or aperiodically monitored or reviewed, and the priority profile adjusted accordingly.

Techniques described and suggested in the present disclosure improve the field of computing, especially the field of data aggregation, transformation, and presentation, by providing, via a graphical user interface, aggregated, transformed, and normalized data in real-time, where the data is obtained from various data sources stored in various formats. As a result, a thorough analysis of the cost-benefit of software applications installed within a distributed computing infrastructure can be performed using the unified data.

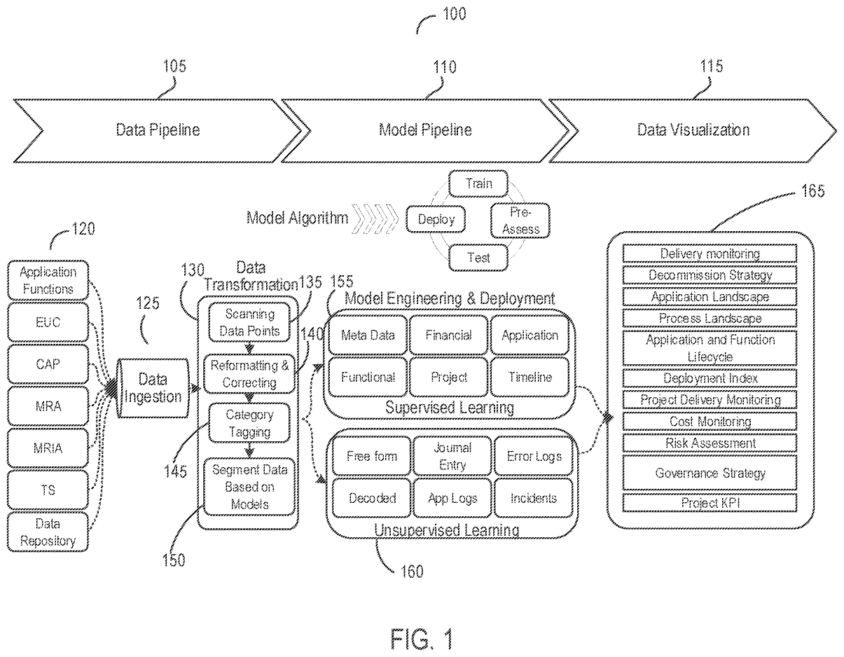

FIG. 1 depicts a block diagram of a platform 100 for aggregating and visualizing data from disparate sources. The platform 100 may carry out or include a data pipeline 105, a model pipeline 110, and a data visualization 115, among others. In the data pipeline 105, the platform 100 may access data sources for retrieval of various pieces of data 120. In the depicted example, the data may include application function, end-user computing (EUC), corrective action plan (CAP), matters requiring attention (MRA), matters requiring immediate attention (MRIA), exchange, and other data repositories, among others. With the retrieval, the platform 100 may perform data ingestion to store on a database 125. The platform 100 may perform a data transformation as part of the data ingestion 130. In transforming, the platform 100 may scan data points 135, reformat and correct the data 140, generate category tags 145, and segment data based on models 150, among others.

Continuing on, in the model pipeline 110, the platform 100 may maintain a set of ML models, including one subset of models established in accordance with supervised learning 155 and another subset of models established in accordance with unsupervised learning 160. Based on the segment to which the data is assigned, the platform 100 may select one of the ML models to apply to the data to produce an output. Under training mode, the platform 100 may use the output to train and update the weights of the models. Under evaluation or runtime mode, the platform 100 may further use the output to provide to the end user. Under data visualization 115, the platform 100 may use the output to generate visualizations to present on a dashboard interface. The generation of the visualization may be in accordance with a template for the type of output, such as delivery monitoring, decommissioning, application landscape, process landscape, application and function lifecycle, deployment index, delivery monitoring, cost monitoring, risk assessment, governance strategies, and key performance indicator (KPI), among others.

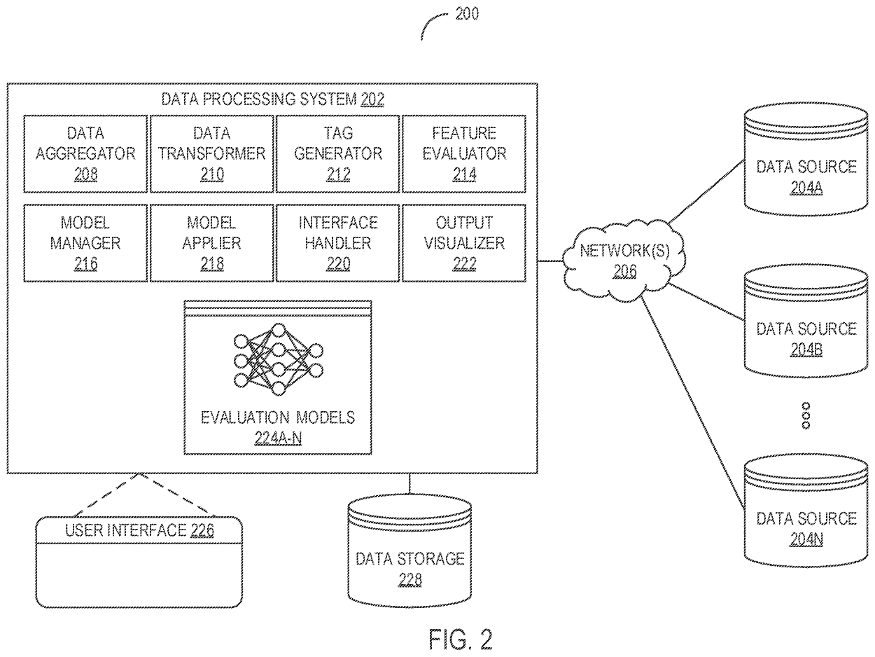

FIG. 2 depicts a block diagram of a system 200 for aggregating data from disparate sources to output information using ML models. The system 200 may include at least one data processing system 202 (sometimes referred herein generally as a computing system or a service) and a set of data sources 204A-N(hereinafter generally referred to data sources 204), among others, communicatively coupled with one or more networks 206. The data processing system 202 may include at least one data aggregator 208, at least one data transformer 210, at least one tag generator 212, at least one feature evaluator 214, at least one model manager 216, at least one model applier 218, at least one interface handler 220, at least one output visualizer 222, and a set of evaluation models 224A-N(hereinafter generally referred to as evaluation models 224), among others. The data processing system 202 may provide at least one user interface 226, among others. The data processing system 202 may include or may have accessibility to at least one data storage 228.

Various hardware and software components of one or more public or private networks 206 may interconnect the various components of the system 200. Non-limiting examples of such networks may include Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols, among others.

The data processing system 202 may be any computing device comprising one or more processors coupled with memory and software and capable of performing the various processes and tasks described herein. The data processing system 202 may be in communication with the data sources 204, among others via the network 206. Although shown as a single component, the data processing system 202 may include any number of computing devices. For instance, the data aggregator 208, the data transformer 210, the tag generator 212, the feature evaluator 214, the model manager 216, the model applier 218, the interface handler 220, and the output visualizer 222 may be executed across one or more computing systems 202.

Within the data processing system 202, the data aggregator 208 may retrieve data from one or more of the data sources 204. The data transformer 210 may perform pre-processing on the retrieved data. The tag generator 212 may generate tags identifying topic categories for data. The feature evaluator 214 may group the data using the tags identifying the categories. The model manager 216 may train, establish, and maintain the evaluation models 224. The model applier 218 may feed and process the data using at least one of the evaluation models 224. The interface handler 220 may manage inputs and output via the user interface 226. The output visualizer 222 may generate visualization using the output from the evaluation models 224. The data source 228 may store and maintain data for use by the components of the data processing system 202.

Each data source 204 may store and maintain various datasets associated with servers, client devices, and other computing devices in a network environment (e.g., the networks 206). In some embodiments, the network environment may correspond to an enterprise network for a group of end-users including at least one data center, one or more branch offices, and remote users. The data source 204 may include a database management system (DBMS) to arrange and organize the data maintained thereon. The data on the data source 204 may be produced from a multitude of applications and processes accessible through the network environment. The applications may be an online banking application, an exchange platform, a word processor, a spreadsheet program, a multimedia player, a video game, or a software development kit, among others. For instance, the data source 204 may store and maintain a transaction log identifying communications exchanged over the network environment, such as between end-user client devices and the servers. Upon production, the servers or end-user client devices may store and maintain the data on the data source 204. The data source 204 may store and maintain the data in accordance with its own specifications, such as formatting and contents of the data. The data maintained on the data source 204 may be accessed by the data processing system 202.

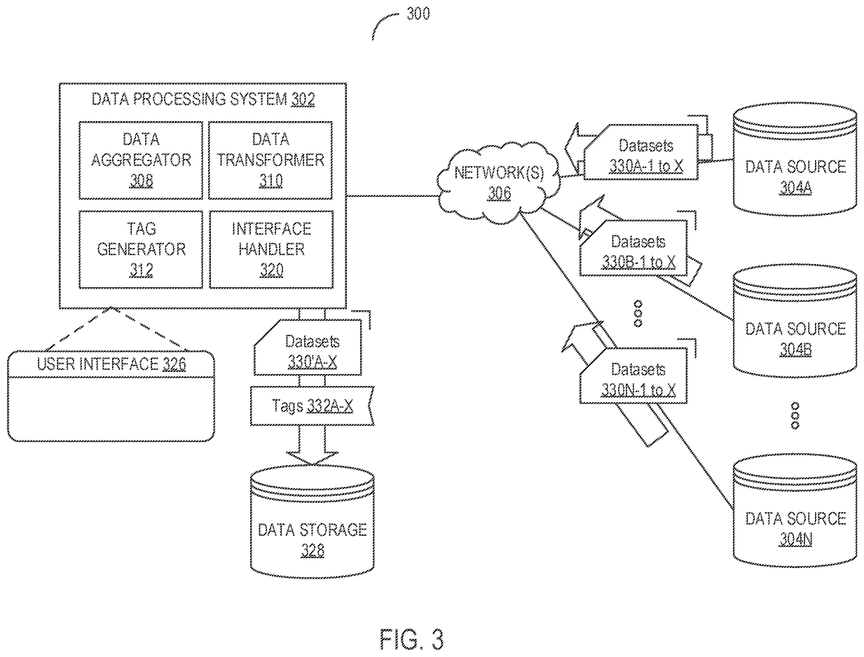

FIG. 3 depicts a block diagram of a system 300 for aggregating data from disparate sources. The system 300 may include at least one data processing system 302 and one or more data sources 304A-N(hereinafter generally referred to as data sources 304), communicatively coupled with one another via at least one network 306. The data processing system 302 may include at least one data aggregator 308, at least one transformer 310, at least one tag generator 312, at least one interface handler 320, and at least one data storage 328, among others. The data processing system 302 may provide at least one user interface 326. Embodiments may comprise additional or alternative components or omit certain components from those of FIG. 3 and still fall within the scope of this disclosure. Various hardware and software components of one or more public or private networks 306 may interconnect the various components of the system 300. Each component in system 300 (such as the data processing system 302 and its subcomponents and the one or more data sources 304) may be any computing device comprising one or more processors coupled with memory and software and capable of performing the various processes and tasks described herein.

Each data source 304 may store and maintain one or more datasets 330A-1 to 330N-X (hereinafter generally referred to datasets 330). The data source 304 may accept, obtain, or otherwise receive the datasets 330 from one or more servers or client devices in a network environment. Each data source 304 may store and maintain the datasets 330 for one or more applications or processes accessible via the network environment. For instance, the first data source 304A may store datasets 330 related to an account balance check operation of an online banking application, whereas the second data source 304B may store datasets 330 associated with an institutional risk management platform. In another example, one or more of the data sources 304 may store and maintain datasets 330 such as a function type, a usage metric, a security risk factor, or a criticality indicator, among others.

The datasets 330 may be stored and maintained in accordance with the specification of the data source 304. The specifications may include, for example, a formatting and contents for the datasets 330. The formatting may identify, specify, or otherwise define a structure of the datasets 330 stored on the data source 304. For instance, the formatting may define a file format or database model for storing and arranging the datasets 330 in the data source 304. The contents may identify, specify, or otherwise define a type of data for the datasets 330 stored on the data source 304. For example, the specified content may define types of fields (sometimes referred herein as attribute or key) and corresponding values in the datasets 330. The specifications for the dataset 330 in one data source 304 may differ from the specifications (e.g., at least one of formatting or content type) for the dataset 330 of another data source 304. For instance, the first data source 304A may have specifications that datasets 330 are to be in the form of field-value pairs for client relationship management, whereas the second data source 304B may have specifications that datasets 330 may be in the form of a transaction log for invocation of operations of a particular application. In some embodiments, a data point corresponding to the resource data or the second resource data may refer to an individual element of a dataset representing information associated with a software application or the distributed computing infrastructure. For example, a data point may correspond to a field-value pair contained within a dataset, such as a usage metric, function type, security risk factor, system criticality measure, or other value derived from the resource data or the second resource data. The indication may be received from a computing device, a database query, a data repository, an application programming interface (API), or another system component configured to access the second resource data.

The data aggregator 308 executing on the data processing system 302 may access each data source 304 to obtain, identify, or otherwise retrieve the datasets 330 from the data source 304. In some embodiments, the data aggregator 308 may accept or receive the datasets 330 sent from each data source 304. The datasets 330 retrieved by the data aggregator 308 may correspond to datasets 330 generated or stored by the data source 304 over a period of time. The period of time may correspond to a sampling window over which the datasets 330 were generated at each data source 304. The period of time may span any amount of time, for example, from a 5 minutes to 2 months since the previous retrieval of the datasets 330 from the data sources 304. In some embodiments, the data aggregator 308 may instruct, command, or otherwise request the datasets 330 from each data source 304 for the specified period of time. With the retrieval, the data aggregator 308 may store and maintain the datasets 330 retrieved from the data sources 304 in the data storage 328 in the original specifications for the datasets 330. The data aggregator 308 may also perform initial scanning of the datasets 330 retrieved from the data sources 304.

With the retrieval, the data transformer 310 executing on the data processing system 302 may perform one or more transformations on the datasets 330. When received, the datasets 330 may initially be in the original specifications (e.g., formatting and content type) of the data source 304. For each dataset 330, the data transformer 310 may change, modify, or otherwise convert the format of the dataset 330 from the original format to at least one format of the data processing system 302 to generate a corresponding new dataset 330′A-X (hereinafter generally referred to as dataset 330′). In some embodiments, the data transformer 310 generates the new dataset 330′ using multiple datasets 330 from one or more data sources 304. The format for the new dataset 330′ may be for entry, feeding, or input to one of the evaluation models of the data processing system 302. The format for the new dataset 330′ may differ from the original format of the dataset 330. In some embodiments, the data transformer 310 may select or identify the format from a set of formats to convert to based on any number of factors, such as the data source 304 or the contents of the original datasets 330, among others. For example, the data transformer 310 may identify the data source 304 as associated with application log data and may select the format for processing the application log data at the data processing system 302.

Continuing on, the data transformer 310 may perform data correction on the datasets 330′ (or datasets 330). With the conversion, the dataset 330′ may include one or more fields for which there are no values from the original corresponding dataset 330. For each dataset 330′, the data transformer 310 may identify or determine whether more data is to be added to the dataset 330′. If there are no missing values in the dataset 330′, the data transformer 310 may determine that no supplemental data is to be added to the dataset 330′. With the determination, the data transformer 310 may maintain the dataset 330′ as is. On the contrary, if there is any portion of the dataset 330′ with missing values, the data transformer 310 may determine that more data is to be added to the dataset 330′. The data transformer 310 may continue to traverse through the datasets 330′ to determine whether more data is to be added.

With the determination that more data is to be added, the data transformer 310 may generate, identify, or retrieve supplemental data to add to the dataset 330′. In some embodiments, the data transformer 310 identifies associated datasets 330′ for the supplemental data. For example, the dataset 330′ with the missing values may be associated with a particular application. In this case, the data transformer 310 may retrieve or identify other datasets 330′ also associated with the application to retrieve the supplemental data. With the retrieval, the data transformer 310 may add the supplemental data to the dataset 330′. In some embodiments, the data transformer 310 may determine or generate the supplemental data using other values in the dataset 330′. For example, the dataset 330′ may have missing values for fields that can be derived from values of other fields in the same dataset 330′. Based on the other values, the data transformer 310 may generate the supplemental data to insert into the dataset 330′. In some embodiments, the data transformer 310 can access or search a knowledge base for the supplemental data to add to the dataset 330′. The knowledge base may be constructed using information from the network environment (e.g., the enterprise network) besides the data sources 304 and may include information about the network environment.

The tag generator 312 executing on the data processing system 302 may determine or generate at least one tag 332A-X (hereinafter generally referred to tag 332) for each dataset 330′ (or dataset 330). The tag 332 may define or identify a topic category of the associated dataset 330′. The topic categories may include, for example, delivery monitoring, decommissioning, application landscape, process landscape, application and function lifecycle, deployment index, delivery monitoring, cost monitoring, risk assessment, governance strategies, and key performance indicator (KPI), among others. The topic categories may correspond to features to be evaluated using one or more ML models for outputting information on the datasets 330′. The tag 332 may be generated and maintained using one or more data structures, such as an array, a linked list, a tree, a heap, or a matrix, among others.

To identify the topic category, the tag generator 312 may process or parse the fields or values within the dataset 330′ using natural language processing (NLP) algorithms, such as automated summarization, text classification, or information extraction, among others. In some embodiments, the tag generator 312 may generate the tag 332 based on the data source 304 from which the dataset 330 is retrieved. For example, the tag generator 312 may identify the topic category for the dataset 330′ as for application-related metrics based on an identification of the data source 304 as storing data for one or more applications in the network environment. With the identification, the tag generator 312 may generate the tag 332 to identify the topic category for the dataset 330′.

In some embodiments, the tag generator 312 identifies or selects the topic category from a set of candidate topic categories for the datasets 330′ retrieved from the data sources 304. The tag generator 312 in conjunction with the interface handler 320 may retrieve, identify, or otherwise receive the set of candidate topic categories via the user interface 326. The interface handler 320 may provide the user interface 326 for presentation on a display coupled with the data processing system 302 or a computing device (e.g., administrator's computing device) in communication with the data processing system 302. The user interface 326 may include one or more user interface elements for defining the candidate topic categories. Upon entry or input via the user interface 326 (e.g., by the user), the interface handler 320 may retrieve or identify the definitions for the topic categories.

With the definitions, the tag generator 312 may compare with the fields and values of each dataset 330′ (or dataset 330) with the set of candidate topic categories. The comparison may be facilitated using NLP techniques as discussed above. Based on the comparison, the tag generator 312 may identify or select the topic category to use as the tag 332 for the dataset 330′. For instance, the tag generator 312 may use a knowledge graph to compare the topic category derived from the dataset 330′ with the candidate topic categories to calculate a semantic distance. The tag generator 312 may select the candidate topic category with the closest semantic distance with the derived topic category to use for the tag 332 for the dataset 330′. In some embodiments, the tag generator 312 may generate or generate a segment corresponding to a group of datasets 330′. The segment may be defined using the common topic category identified in the tags 332 of the subset of datasets 330′.

Upon generation, the tag generator 312 may store and maintain the tags 332 along with the datasets 330′ on the data storage 328. In some embodiments, the tag generator 312 can insert or add the tags 332 to the datasets 330′. For instance, the tag generator 312 may add the tag 332 as a field-value pair along with other field-value pairs of the associated dataset 330′. In some embodiments, the tag generator 312 determines or generates at least one association between the tag 332 and the corresponding dataset 330′ from which the tag 332 was generated. The tag generator 312 may store the association on the data storage 328. In some embodiments, the tag generator 312 may store the segment corresponding to group of datasets 330′ defined using the common topic category of tags 332 of each dataset 330′ in the group. The tag generator 312 may store and maintain an association between the segment of the datasets 330′ with the tag 332 on the data storage 318.

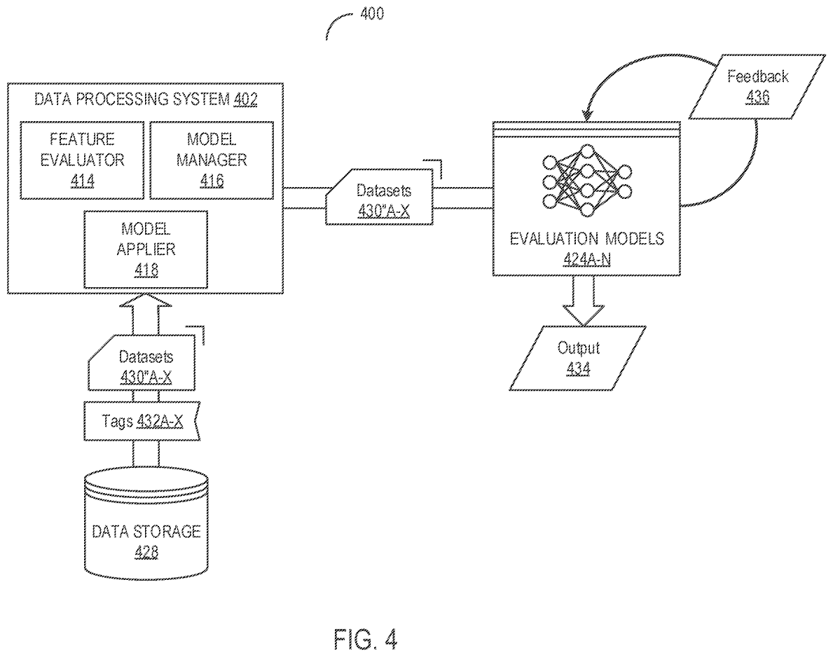

FIG. 4 depicts a block diagram of a system 400 for training ML models using aggregated data. The system 400 may include at least one data processing system 402. The data processing system 402 may include at least one feature evaluator 414, at least one model manager 416, at least one model applier 418, one or more evaluation models 424A-N(hereinafter generally referred to as evaluation models 424), and at least one data storage 428, among others. In the system 400, the data processing system 402 and its components may be in a training or learning mode to train at least one of the evaluation models 424. Embodiments may comprise additional or alternative components or omit certain components from those of FIG. 4 and still fall within the scope of this disclosure. Various hardware and software components of one or more public or private networks may interconnect the various components of the system 400. Each component in system 400 (such as the data processing system 402 and its subcomponents) may be any computing device comprising one or more processors coupled with memory and software and capable of performing the various processes and tasks described herein.

The feature evaluator 414 executing on the data processing system 402 may identify or select a subset of datasets 430″A-X (hereinafter generally referred to as datasets 430″) using at least one feature for evaluation using at least one of the evaluation models 424. The feature may correspond to at least one topic category for the datasets 430″ to be evaluated or analyzed for at least one metric, such as utility, risk level, performance, health, among others. The utility may indicate a degree of usefulness of the feature evaluated. The risk level may correspond to a degree of vulnerabilities or susceptibility to lapses (e.g., security, downtime, failure, or breakdown) from the feature assessed. The performance may be a metric indicating proper functioning of components of the feature evaluated. The health may correspond to a condition of the features evaluated. The subset of datasets 430″ may be obtained, received, or otherwise retrieved from over a period of time. The period of time may correspond to a sampling window over which the datasets were generated at each data source. The datasets 430″ may be converted into the format compatible for inputting into the evaluation model 424.

In some embodiments, the feature evaluator 414 may select or identify the subset of datasets 430″ using the at least one tag 432. The tag 432 may identify the topic category for each associated dataset 430″. The topic category defined by the tag 432 may correspond to the feature to be evaluated for the metric (e.g., utility or risk level). The feature evaluator 414 may traverse through the set of possible topic categories identified across the tags 432 of the data storage 428 to identify corresponding subsets of datasets 430″. In some embodiments, the feature evaluator 414 may identify the subset of datasets 430″ using the corresponding period of time to be evaluated for the network environment. In some embodiments, the feature evaluator 414 may produce or generate a segment corresponding to the subset of datasets 430″. The segment may be defined using the feature or by extension the common topic category identified in the tags 432 of the subset of datasets 430″. In some embodiments, the feature evaluator 414 may identify the segment corresponding to the subset of datasets 430″ (e.g., previously defined by the tag generator) stored on the data storage 428.

In conjunction, the model manager 416 executing on the data processing system 402 may initialize, establish, and maintain the set of evaluation models 424. The set of evaluation models 424 may be for evaluating or analyzing the corresponding set of features. Each evaluation model 424 may correspond to at least one of the topic categories present in the tags 432 of the datasets 430″. Each evaluation model 424 may be dedicated or otherwise configured to process datasets 430″ of the feature and by extension the associated topic category of the tag 432. In general, each evaluation model 424 may have: at least one input corresponding to the subset of datasets 430″, at least one output from processing the input, and a set of parameters (e.g., weights) to process the inputs to generate the output. To train the evaluation model 424, the model manager 416 may invoke the model applier 418 to apply the identified datasets 430″.

At least one of the evaluation models 424 may be initialized, trained, or established in accordance with supervised learning. For example, the evaluation model 424 may be an artificial neural network (ANN), decision tree, regression model, Bayesian classifier, or support vector machine (SVM), among others. At least one of the evaluation models 424 may be initialized, trained, or established in accordance with unsupervised learning. For instance, the evaluation model 424 may be a clustering model, such as hierarchical clustering, centroid-based clustering (e.g., k-means), distribution model (e.g., multivariate distribution), or a density-based model (e.g., density-based spatial clustering of applications with noise (DBSCAN)), among others. Other techniques may be used to initialize, train, and establish the evaluation models 424, such as weakly supervised learning, reinforcement learning, and dimension reduction, among others.

In some embodiments, the model manager 416 in conjunction with the feature evaluator 414 may identify or select the evaluation model 424 from the set of evaluation models 424 to be trained. The selection may be based on the subset of datasets 430″, the feature to be evaluated, or the topic category identified in the tags 432 of the selected subset, among others. For instance, each evaluation model 424 may be dedicated or configured to process subsets of datasets 430″ for a particular feature or by extension category topic. The model manager 416 may identify the evaluation model 424 to be used to process the identified subset of datasets 430″. In some embodiments, the model manager 416 may determine whether an evaluation model 424 exists or is otherwise established for the feature. If the evaluation model 424 does not exist, the model manager 416 may create and initialize the evaluation model 424. For example, the model manager 416 may instantiate the evaluation model 424 for processing the datasets 430″ for the feature to be evaluated. Otherwise, if the evaluation model 424 does exist, the model manager 416 may use the evaluation model 424 to continue training using the selected subset of datasets 430″.

In some embodiments, the model manager 416 selects or identifies a testing dataset and a validation dataset from the subset of datasets 430″. The model manager 416 may select, define, or otherwise assign a portion of the subset of datasets 430″ as the testing dataset. In addition, the model manager 416 may select, define, or otherwise assign a remaining portion of the subset of datasets 430″ as the validation dataset. The testing dataset may be used as input to the evaluation model 424 to generate a predicted output and the validation dataset may be used to as the expected output to check the predicted output against. The checking of the expected output form the validation dataset with the predicted output from inputting the testing dataset into the evaluation model 424 may be used to update the parameters of the evaluation model 424. With the definition of the testing and validation datasets, the model manager 416 may provide or pass datasets 430″ corresponding to the testing dataset to the model applier 418 to apply to the identified evaluation model 424.

The model applier 418 executing on the data processing system 402 may apply at least one of the evaluation models 424 to the subset of datasets 430″ (e.g., the test dataset). With the selection of the evaluation model 424, the model applier 418 may feed the subset of datasets 430″ into the inputs of the evaluation model 424. In feeding, the model applier 418 may process the input dataset 430″ in accordance with the parameters of the evaluation model 424. From processing with the evaluation model 424, the model applier 418 may produce or generate at least one output 434 for the input dataset 430″. The output 434 may correspond to, identify, or otherwise measure a predicted usefulness, risk level, performance metric, health level, among others. For example, for an input dataset 430″ with application-related data, the output 434 may identify a likelihood that a particular feature of the application is deprecated or in current use.

The model applier 418 may apply the parameters of the evaluation model 424 in accordance with the model architecture. For example, when the evaluation model 424 is an artificial neural network, the model applier 418 may process the input dataset 430″ using the kernel weights of the artificial neural network to generate the output 434. The output may indicate a degree of usefulness, risk, performance, or health for the input dataset 430″. When the evaluation model 424 is a clustering model, the model applier 418 may identify the output 434 from where the input dataset 430″ is situated within a region of the feature space defined by the clustering model. The region may correspond to a classification for the input dataset 430″ indicating usefulness, risk level, performance metric, or health level, among others.

Using the output 434, the model manager 416 may calculate, determine, or otherwise generate at least one feedback 436 for the evaluation model 424. The generation of the feedback 436 may be in accordance with the learning technique used to establish or train the evaluation model 424. In some embodiments, the model manager 416 may validate the evaluation model 424 using the output 434 and at least a portion of the datasets 430″ (e.g., the validation dataset). When supervised learning is used, the model manager 416 may compare the output 434 from the input dataset 430″ of the test dataset with the expected output. The expected output may be acquired or obtained from the validation dataset. Based on the comparison, the model manager 416 may determine the feedback 436 to indicate an amount of deviation between the predicted output 434 and the expected output. When unsupervised learning is used, the model manager 416 may determine a shift in parameters for the evaluation model 424 to use at the feedback 436. For instance, for a clustering model, the feedback 436 may indicate the amount that a centroid for a particular classification is to be modified based on the newly fed input datasets 430″. According to the feedback 436, the model manager 416 may modify, change, or otherwise update the parameters of the evaluation model 424.

The model manager 416 may update and re-train the evaluation models 424 any number of times, and repeat the operations discussed above. For example, the model manager 416 in conjunction with the feature evaluator 414 may identify another subset of datasets 430″ for a feature to be evaluated from another (e.g., subsequent) time period. With the identification, the model manager 416 may select the evaluation model 424 to process the subset of datasets 430″. The model applier 418 may apply the selected evaluation model 424 to the subset of datasets 430″ to generate the output 434. Using the output 434, the model manager 416 may determine the feedback 436 with which to update the parameters of the evaluation model 424. The data processing system 402 may switch between the training mode to retrain and update the evaluation model 424, and the runtime mode to apply the evaluation models 424 to newly acquired data.

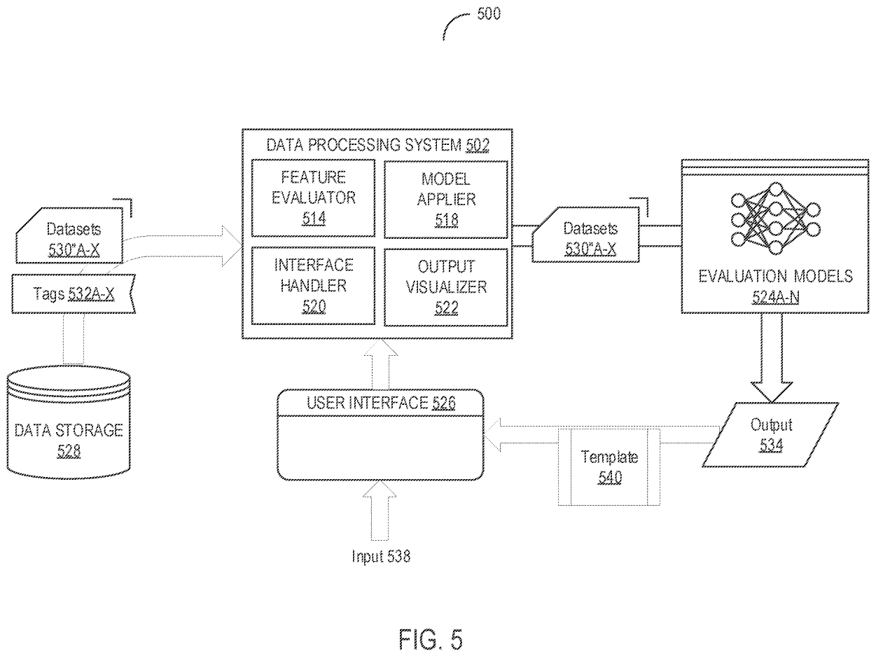

FIG. 5 depicts a block diagram of a system 500 for processing aggregated data using ML models for output. The system 500 may include at least one data processing system 502. The data processing system 502 may include at least one feature evaluator 514, at least one model applier 518, at least one interface handler 520, at least one output visualizer 522, one or more evaluation models 524A-N(hereinafter generally referred to as evaluation models 524), and at least one data storage 528, among others. In the system 500, the data processing system 502 and its components may be in a runtime or evaluation mode to apply at least one of the evaluation models 524 to new incoming data. Embodiments may comprise additional or alternative components or omit certain components from those of FIG. 5 and still fall within the scope of this disclosure. Various hardware and software components of one or more public or private networks may interconnect the various components of the system 500. Each component in system 500 (such as the data processing system 502 and its subcomponents) may be any computing device comprising one or more processors coupled with memory and software and capable of performing the various processes and tasks described herein.

The interface handler 520 executing on the data processing system 502 may provide the user interface 526 with which to select the feature to be evaluated using at least one of the evaluation models 524. The interface handler 520 may provide the user interface 526 for presentation on a display coupled with the data processing system 502 or a computing device (e.g., administrator's computing device) in communication with the data processing system 502. The user interface 526 may include one or more user interface elements (e.g., command button, radio button, check box, slider, or text box) for identifying or selecting the feature (or the topic category) to be evaluated. For instance, the user interface 526 may include a set of user interface elements corresponding to a menu of features from which the user can check or select for analysis.

With the presentation, the interface handler 520 may monitor the user interface 526 for at least one input 538 by the user. The interface handler 520 may use event handlers in the user interface elements of the user interface 526 to monitor. Upon detection of the input 538 on the user interface 526, the interface handler 520 may obtain, identify, or otherwise receive the selection of the feature to be evaluated. The input 538 may correspond to a user interface on the user interface element of the user interface 526. The feature may correspond to the user interface element in the user interface 526 on which the input 538 is detected.

The feature evaluator 514 executing on the data processing system 502 may identify or select a subset of datasets 530″A-X (hereinafter generally referred to as datasets 530″) using at least one feature for evaluation using at least one of the evaluation models 524. The feature may correspond to at least one topic category for the datasets 530″ to be evaluated or analyzed for at least one metric, such as utility, risk level, performance, health, among others. The subset of datasets 530″ may be obtained, received, or otherwise retrieved from over a period of time. The period of time may correspond to a sampling window over which the datasets were generated at each data source. The period of time for the datasets 530″ for evaluation may differ from the period of time of datasets that were used to initialize, train, and establish the evaluation models 524.

In some embodiments, the feature evaluator 514 selects or identifies the subset of datasets 530″ using the selection of the feature via the user interface 526. In some embodiments, the feature evaluator 514 can find, select, or otherwise identify the tag 532 corresponding to the selected feature. The tag 532 may identify the topic category for each associated dataset 530″. The topic category defined by the tag 532 may correspond to the feature to be evaluated for the metric (e.g., utility or risk level). With the identification, the feature evaluator 514 may select or identify the subset of datasets 530″ using the tag 532 corresponding to the selected feature. In some embodiments, the feature evaluator 514 may identify the segment corresponding to the subset of datasets 530″ (e.g., previously defined by the tag generator) stored on the data storage 528. The segment may correspond to the datasets 530″ associated with the selected feature.

In conjunction, the feature evaluator 514 may identify or select the evaluation model 524 from the set of evaluation models 524 to be used to process the dataset 530″. The selection may be based on the subset of datasets 530″, the feature to be evaluated, or the topic category identified in the tags 532 of the selected subset, among others. For instance, each evaluation model 524 may be dedicated or configured to process subsets of datasets 530″ for the selected feature or by extension category topic. In general, each evaluation model 524 may have: at least one input corresponding to the subset of datasets 530″, at least one output from processing the input, and a set of parameters (e.g., weights) to process the inputs to generate the output. To train the evaluation model 524, the feature evaluator 514 may invoke the model applier 518 to apply the identified datasets 530″.

The model applier 518 executing on the data processing system 502 may apply at least one of the evaluation models 524 to the subset of datasets 530″ identified using the selected feature. With the selection of the evaluation model 524, the model applier 518 may feed the subset of datasets 530″ into the inputs of the evaluation model 524. In feeding, the model applier 518 may process the input dataset 530″ in accordance with the parameters of the evaluation model 524. From processing with the evaluation model 524, the model applier 518 may produce or generate at least one output 534 for the input dataset 530″. The output 534 may correspond to, identify, or otherwise measure a predicted usefulness, risk level, performance metric, health level, among others. For example, for an input dataset 530″ with application-related data, the output 534 may identify a likelihood that a particular feature of the application is deprecated or in current use.

The output visualizer 522 executing on the data processing system 502 may render, display, or otherwise present at least one visualization of the output 534 on the user interface 526 using at least one template 540 for the feature. The output visualizer 522 may identify or select the template 540 from a set of templates for the set of potential features and by extension the topic categories for the tags 532. The selection of the template 540 may be based on the selected feature, the topic categories for the tag 532 associated with the input dataset 530″, the output 534 from the evaluation model 524, the evaluation model 524 used to generate the output 534, among others. Each template 540 may be pre-generated or pre-configured for presenting the information from the output 534.

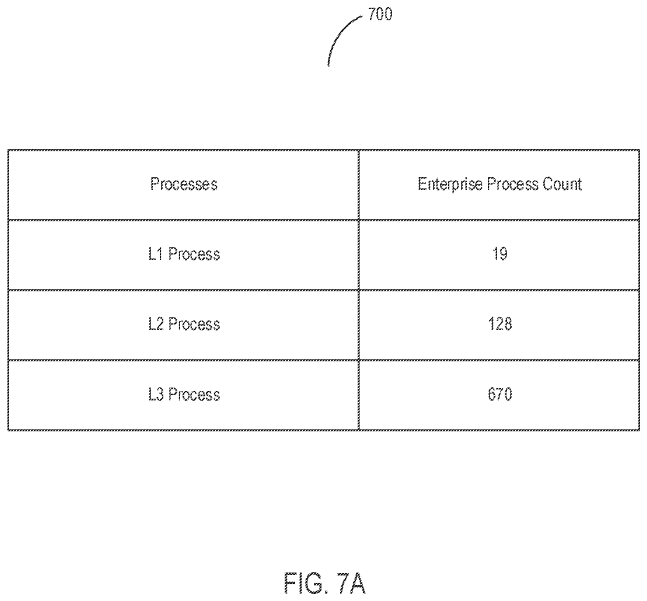

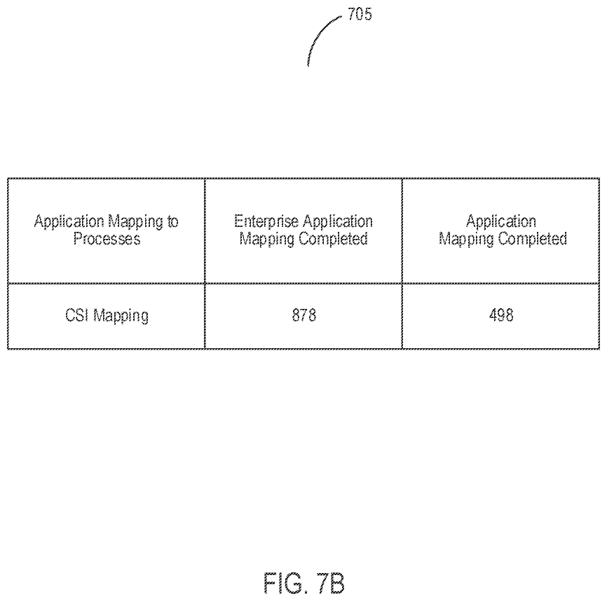

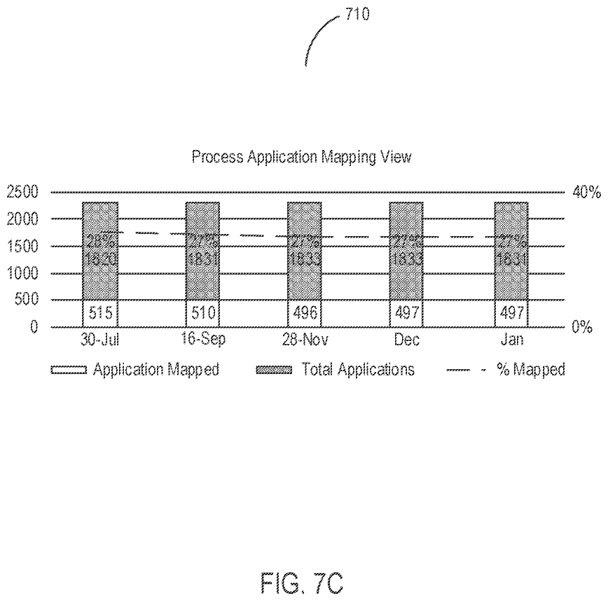

In accordance with the template 540, the output visualizer 522 may create, produce, or otherwise generate the visualization of the output 534. The template 540 may define or specify a visualization of the information identified in the output 534. For example, the template 540 may specify the information (e.g., predicted usefulness, risk level, performance metric, or health level) as indicated in the output 534 to be presented in a bar graph, a table, a box plot, a scatter plot, a pie chart, a Venn diagram, histogram, or fan chart, among others. The template 540 may identify one or more user interface elements with which the user can use to drill down or navigate the information for the output 534. Using the specifications of the template 540, the output visualizer 522 may generate the visualization of the information as identified in the output 534. Examples of the visualizations are shown in FIGS. 7A-9E.

In this manner, the data processing system may reduce the amount of time and effort spent by user in trying to manually track down individual data sources to track and fetch data by retrieving datasets originally stored across disparate data sources in the network environment. With the ready retrieval of the datasets, the data processing system may transform the datasets in a manner amenable for processing by evaluation models. The ability to process the datasets for evaluation models can result in uncovering and detecting issues across multiple applications and processes in the network environment. With repeated training of the evaluation models using datasets with successive sampling periods, the data processing system may be able to provide more accurate and refined output.

Furthermore, the data processing system can also use the templates to produce visualizations for easy digestion via the dashboard information by the users. As such, problems affecting the performance of applications or processes on servers across the network may be quickly and readily pinpointed and addressed. In addition, the insight and information from these visualizations of the output may be used to assess and create a long-term (e.g., 1 to 10 years) strategy for improving performance and enhancing risk management of the overall network environment. The output generated by the data processing system may also improve the overall performance of the servers and client devices in the network, for instance, by reducing the computer and network resources tied up due to previously undetectable issues.

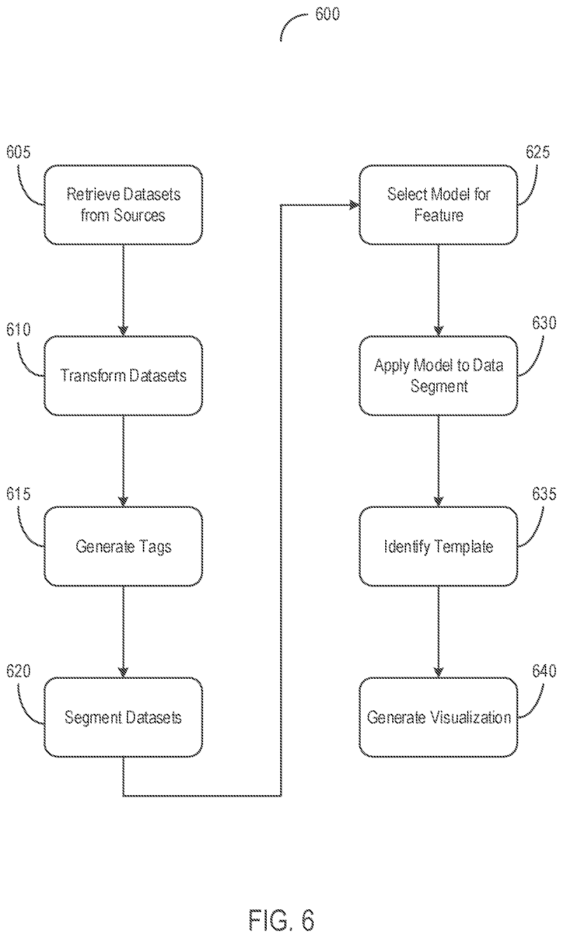

FIG. 6 depicts a flow diagram of a method 600 of aggregating data from disparate sources to output information using ML models. Embodiments may include additional, fewer, or different operations from those described in the method 600. The method 600 may be performed by a service (e.g., a data processing system) executing machine-readable software code, though it should be appreciated that the various operations may be performed by one or more computing devices and/or processors.

At step 605, a service may retrieve datasets from data sources. Each of the data sources may store and maintain datasets, in accordance to the specification of the data source. The specifications may include a format and contents for datasets to be stored and maintained at the data source. The data for the datasets may be generated by various applications, processes, and computing devices in the computing network (e.g., enterprise network). The service may retrieve the datasets from these data sources over a period of time.

At step 610, the service may transform the datasets retrieved from the data sources. Upon retrieval from the data source, the service may transform each dataset from the original formatting to a formatting for application to one of a set of machine learning models. In addition, the service may perform data correction or augmentation for missing data in the converted datasets. At step 615, the service may generate tags for each datasets using the contents (e.g., fields or values) of the dataset. The tag may identify a topic category for the dataset. At step 620, the service may segment the datasets by the topic categories as identified in the tags.

At step 625, the service may select a machine learning model for evaluating the dataset. The service may maintain a set of machine learning models. Each model may be dedicated to or configured to process datasets for certain topic categories. The service may select the model based on the feature or topic category to be evaluated. At step 630, the service may apply the selected model to the segment of datasets identified using the tags. In applying, the service may process the segment of datasets in accordance with the parameters of the machine learning model to generate an output.

At step 635, the service may identify a template with which to generate a visualization of the output from the machine learning model. The template may specify a form for visualizing the information identified in the output from the model. The template may be identified using the feature or topic category analyzed from applying the machine learning model to the segment of dataset. At step 640, the service may generate the visualization of the output in accordance with the template. With the generation, the service may present the visualization of the information of the output on a dashboard interface.

FIGS. 7A-C depict screenshots of visualizations 700-710 of processes and application mapping presented on a dashboard interface. The visualization 700 may provide a view of level 1 (L1), level 2 (L2), and level 3 (L3) processes in L1, L2, L3 process taxonomy defined to have a common vocabulary for the classification of processes that facilitates easier communication, governance, and reporting, helping improve diverse stakeholder alignment and managements in a table view. L I may correspond to a lifecycle of services provided internally and externally through the enterprise and may be outside of a line (e.g., a process) and may be unique to a specific function (e.g., addition of a user). L2 may correspond to a logical order of processes directly underpinning the delivery of the L1 and may be not overly specific to a particular function or the same as a L1 (e.g., account opening and setup). L3 may correspond to unique and distinct processes needed to complete the L2 process and may be anything other than a process step that is to connect to a L2 process (e.g., Know Your Client (KYC) onboarding analysis). The visualization 705 may provide a view on a number of enterprise and sector applications mapped to distinct processes, among others, in a table view. The visualization 710 may provide the view of total applications which are mapped and not mapped to the process defined to services in a table view.

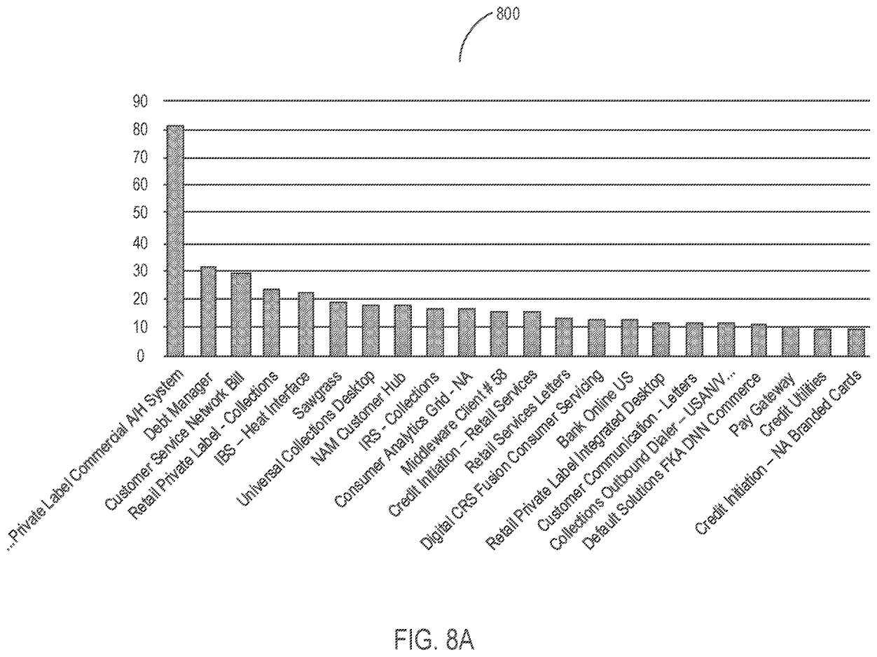

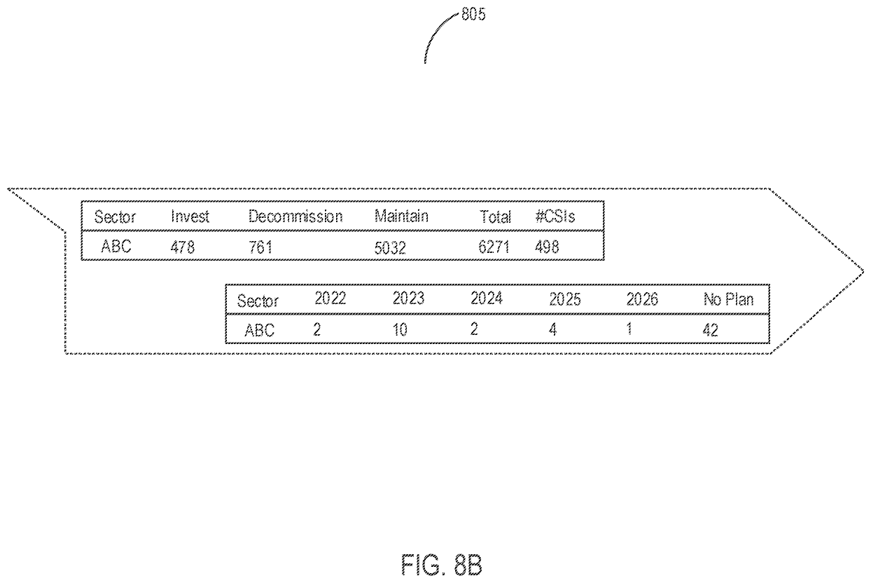

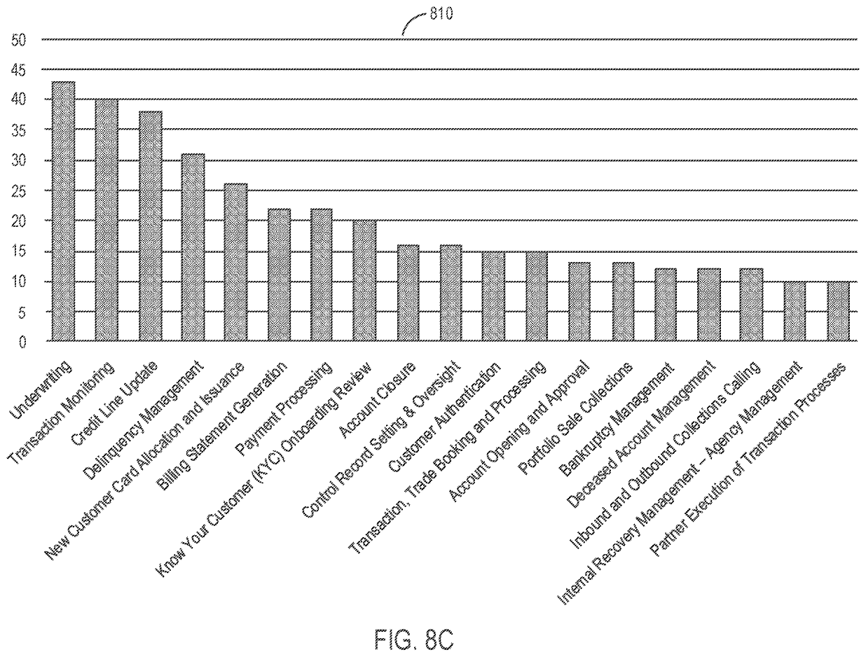

FIGS. 8A-C depict screenshots of visualizations 800-810 characterizing applications generated as presented on a dashboard interface. The visualizations 800-810 may identify how the applications can provide analysis regarding process cycles, leveraging the evaluations models and insights. The visualization 800 may provide a histogram view of multiple technology applications supporting more than functions for a particular line of and can identify opportunities to optimize as part of target state. The visualization 805 may be a timeline view of a number of applications to be decommissioned, maintained, or updated, among other statistics. The visualization 805 may identify mapping of functions such as (1) client information collection, (2) client account analysis, (3) account set up, and (4) checking creation and delivery along with tags of invest, decommission, or maintain. The visualization 805 may also provide how many applications can be decommissioned over time. The visualization 810 may provide a bar chart view of multiple processes that are supported by more than or equal to ten applications for a particular line or group in the enterprise.

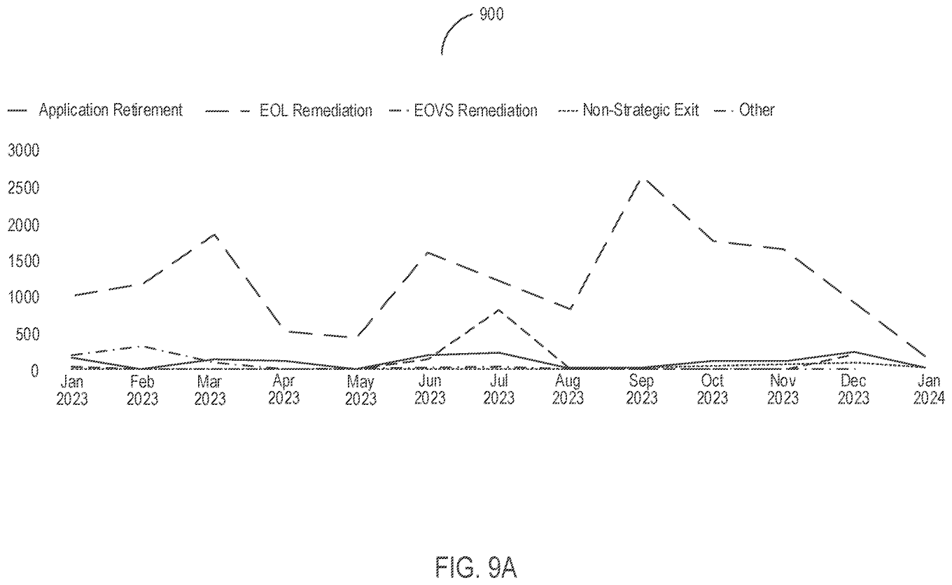

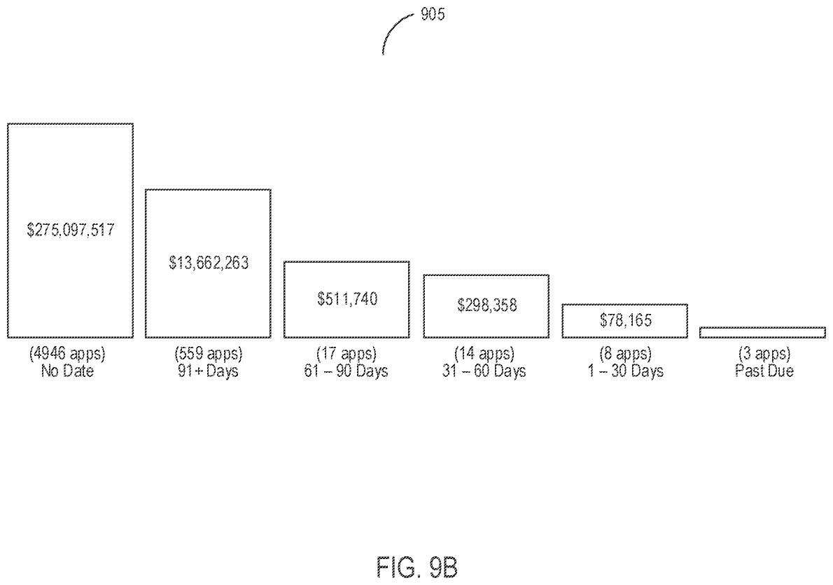

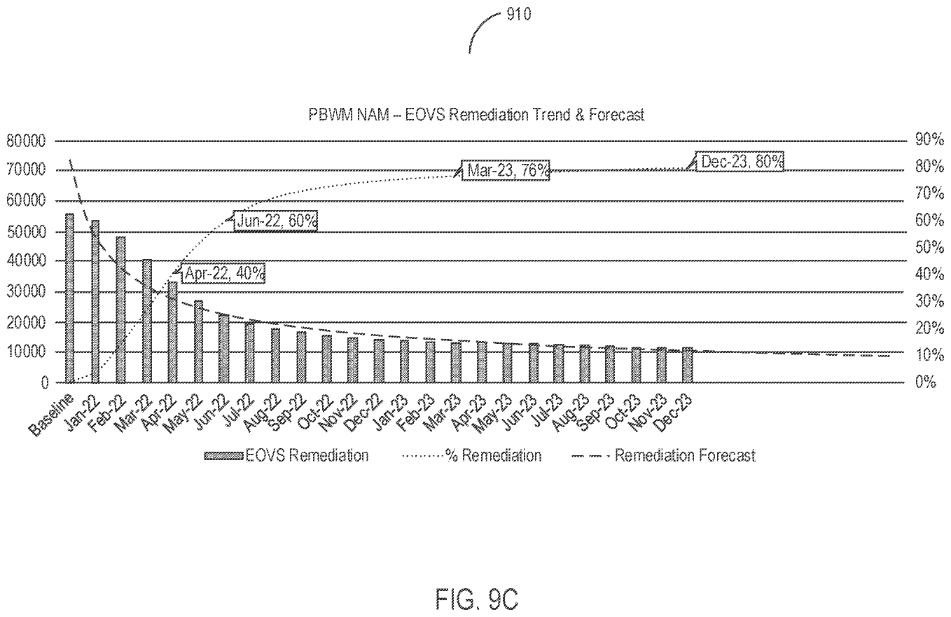

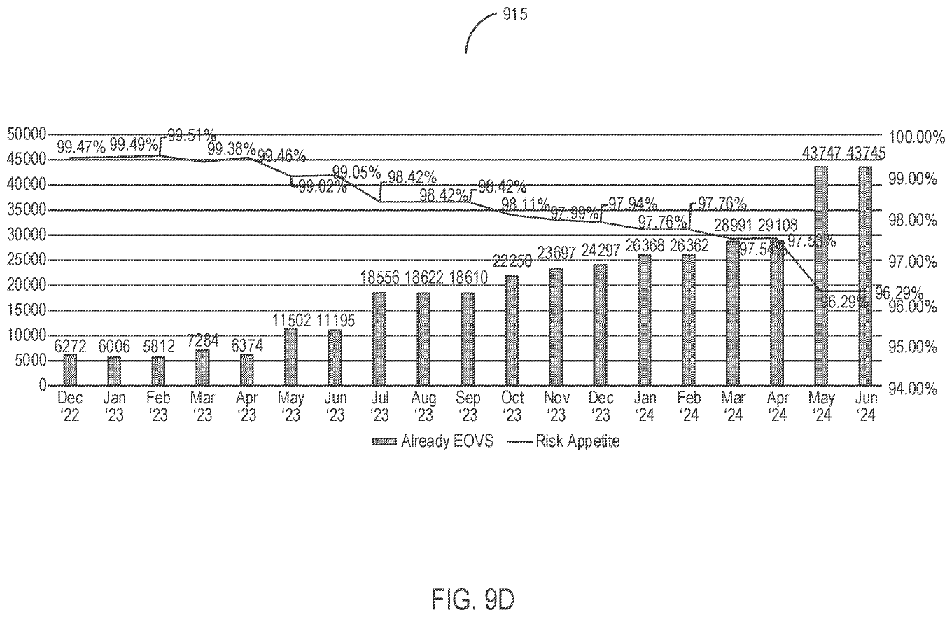

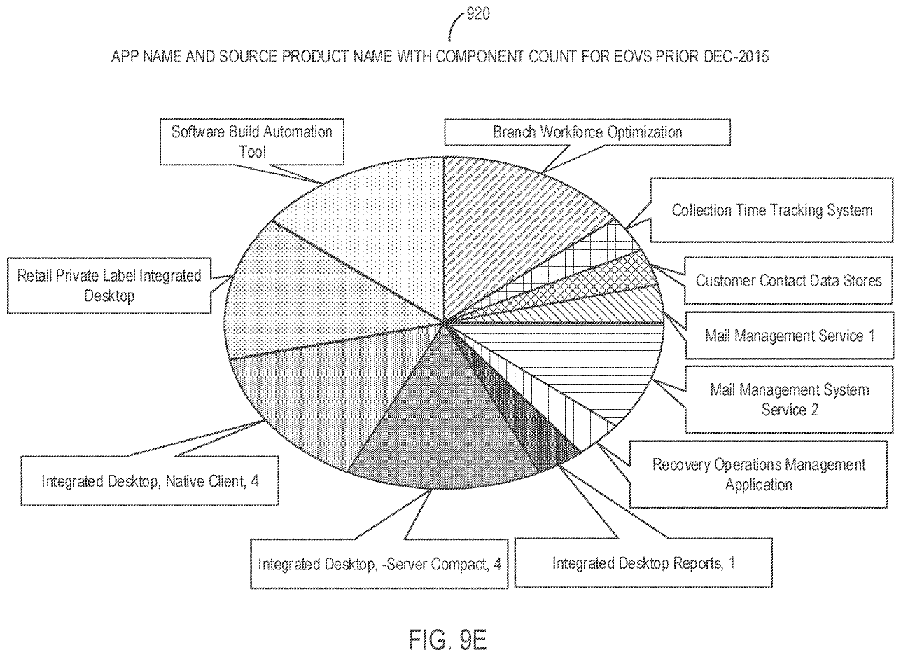

FIGS. 9A-E depict screenshots of visualizations 900-920 of risk factors from application processes as presented on a dashboard interface. The visualization 900 may be a graph of the predictions of application decommissions. The visualization 900 may show the prediction of retirement of applicable applications, remediation of application components that are end of life (EOL), remediation of application components that are end of vendor support (EOVS) and other decommissioning or remediation details for the next year. The visualization 905 may be a histogram, or multiple histograms, showing monetary values for retiring various applications. In the visualization 905, the summary of the application retirement status and the monthly chargeback details for applications that are past due and for applications that would be due within 180 days are visualized with the ingested data.

The visualization 910 may be a summary graph of trends and predictions for remediating applications. The visualization 910 may provide the end of vendor support remediation prediction for application components within a particular sector are depicted along with the predicted trend and predictions for the EOVS remediation. The visualization 915 may be a graph of a risk appetite across time. The visualization 915 shows the risk appetite predictions against monthly open end of vendor support (EOVS) components. This chart predicts the risk appetite for the next 12 months and indicates the number of EOVS items that needs to be remediated to mitigate the risk (Risk Appetite: color 1>=99.4%, color 2 between 99.0% and 99.4% and color 3<99.0%). The visualization 920 may be a pie chart of component counts for various applications. In the visualization 920, the pie chart may list the impacted applications and the corresponding component count that are still end of vendor support (EOVS) from December 2015 and not yet remediate.

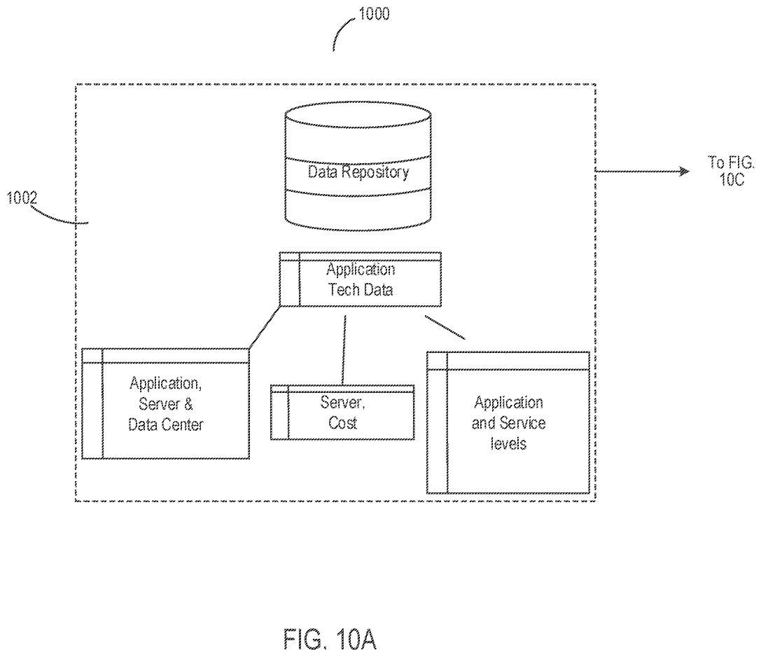

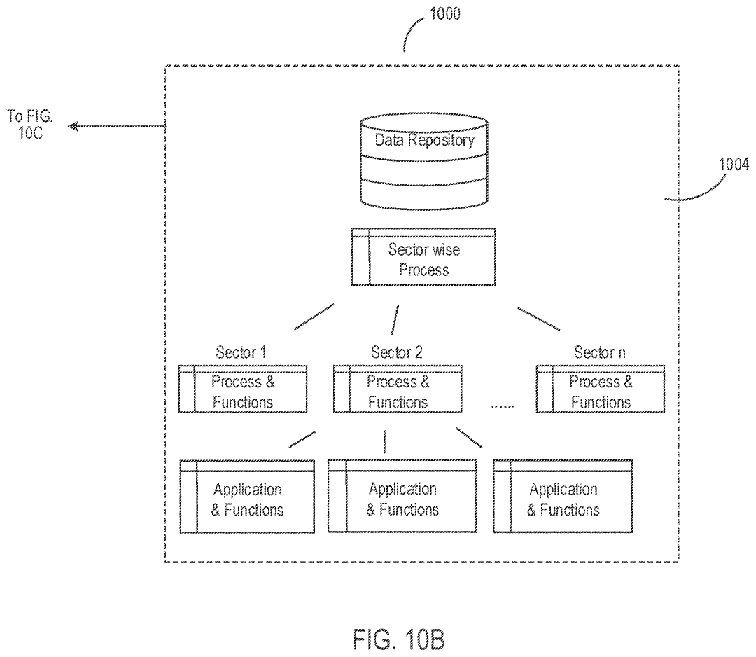

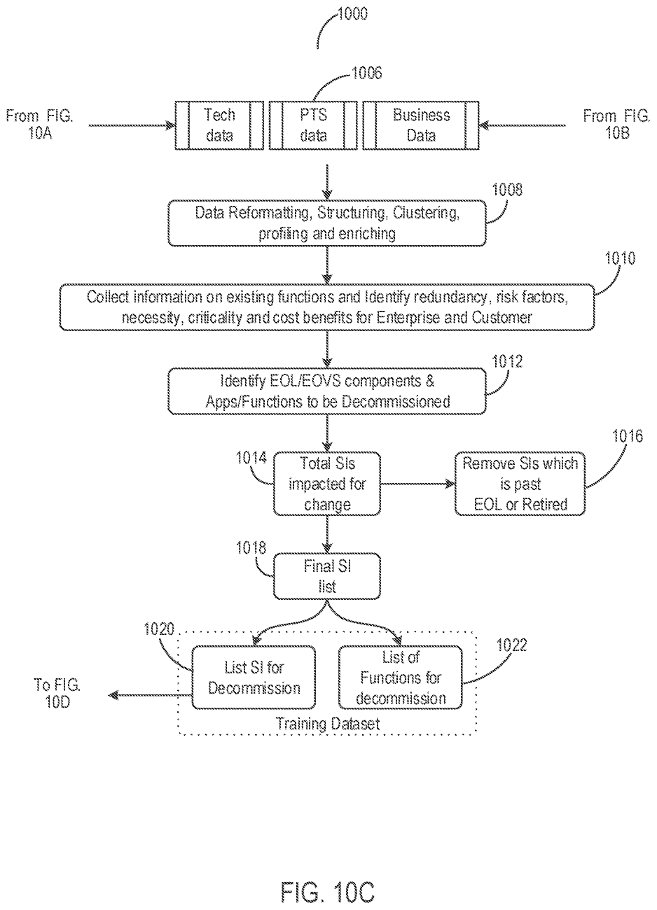

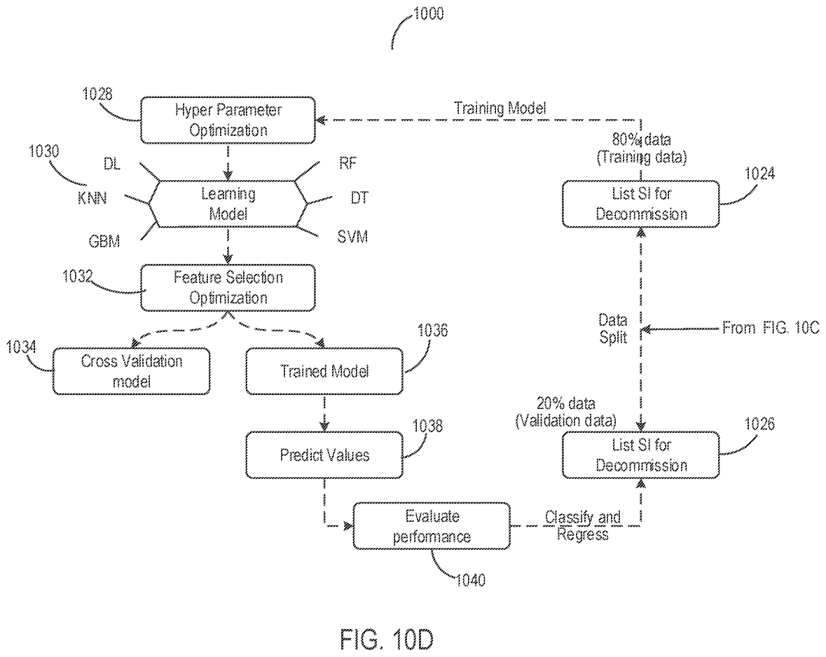

FIGS. 10A-D depict a flow diagram of a method 1000 for aggregating data related to applications and outputting information on application commission using ML models. Embodiments may include additional, fewer, or different operations from those described in the method 1000. The method 1000 may be performed by a service (e.g., a data processing system) executing machine-readable software code, though it should be appreciated that the various operations may be performed by one or more computing devices and/or processors. Starting from FIG. 10A, a service may access data from a data repository 1002. The data repository may include application tech data including information related to application, server, and data center, server costs, and application and service level agreements, among others. In conjunction, moving onto FIG. 10B, the service may access data from a sector data repository 1004). The sector data repository may include data for processes with functions and applications with functions from individual sectors 1 through n.

Continuing onto FIG. 10C, the service may aggregate the data from multiple data sources 1006. The data sources may include from the data repository 1002 or the sector data repository 1004, as well as from a process tracking system (PTS). The PTS may be a management tool used to create and maintain operations, budgets, predictions and actual in both full time equivalent (FTE), as well as the status and the start or end date for each operation. The PTS may also allow managers to track resource allocation. With the aggregation, the service may reformat, structure, cluster, profile, and enrich the aggregated data 1008. In addition, the service may collect information on existing functions to identify redundancies, risk factors, necessity, criticality, and cost benefits for the enterprise network and customers 1010. The service may identify components, applications, and functions to be decommissioned in the aggregated data 1012. The components may be at an end of life (EOL) in which the component vendor has announced that maintenance and extended support is to be terminated. The components may be at an end of vendor support (EOVS) in which the vendor for the component announced that publicly available extended support is to end for a given product version. The service may determine a total number of resources impacted 1014. They may identify profiles of applications and may aggregate details from messages, user interfaces, infrastructure or software deployment details, and other information. From the total number, the service may remove SIs which are past the EOL or retired 1016. The service may then compile a final CSI list 1018. The service may generate training and validation datasets including a list of CSIs for commissions and a list of functions for decommission 1020 and 1022.

Referring now to FIG. 10D, the service may split the data by using the 80% of the list of CSI for decommission as training data 1024 and using the remaining 20% for validation (1026). The service may use the training dataset to perform hyper parameter optimization 1028. The service may use one or more learning models to train, such as a deep learning model, a nearest neighbors model, a decision tree, a radio frequency mode, a gradient boosting machine, or a support vector machine, among others 1030. The service may perform a feature selection optimization 1032 to derive a cross-validation model 1034 and to generate a training model 1036. The service may use the trained model to generate predicted values 1038 and use the predicted values to evaluate performance 1040. The service may classify and regress the predicted values to add to the validation dataset.

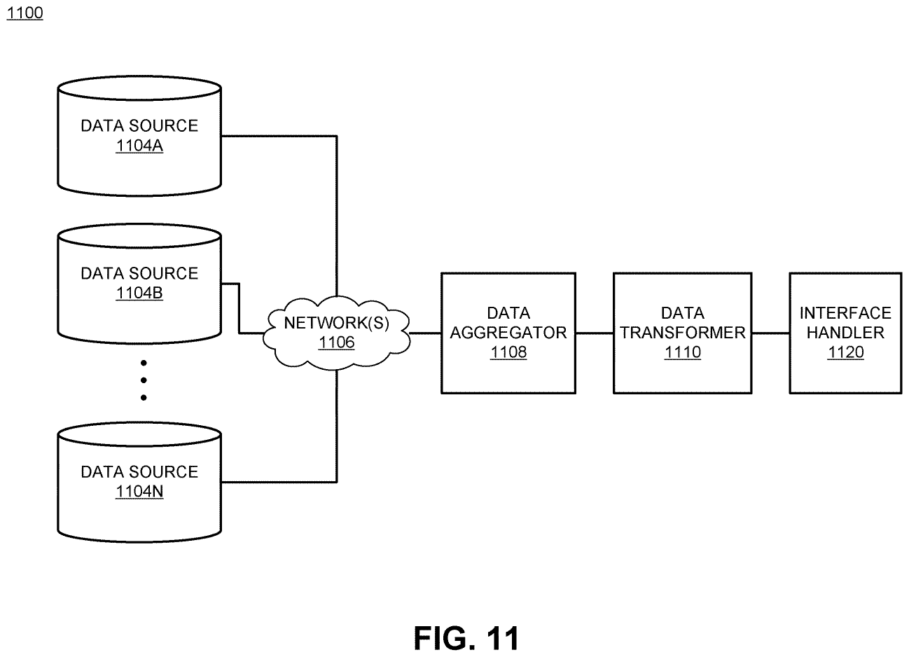

FIG. 11 illustrates an example of system 1100 to generate insights for software applications, in accordance with an embodiment. System 1100 can be part of system 200 illustrated in FIG. 2 for aggregating data from disparate sources to output information using statistical and/or artificial intelligence (AI) models. System 1100 can be part of system 300 illustrated in FIG. 3 for aggregating data from disparate sources. System 1100 can be part of system 400 illustrated in FIG. 4 for training statistical and/or AI models using aggregated data. System 1100 can be part of system 500 illustrated in FIG. 5 for processing aggregated data using AI models for output.

In at least one embodiment, system 1100 can include a distributed computing architecture comprising a plurality of computing nodes interconnected over a communication network (e.g., network 1106). Each computing node may be a physical or virtual machine having at least one processor, hardware accelerators (e.g., GPU, FPGA, ASIC, etc.), memory, storage, and a network interface. Computing nodes may be geographically dispersed and may operate in coordination to perform distributed data processing, resource sharing, and workload balancing. The distributed computing architecture may include a coordination service configured to manage orchestration of services and applications across computing nodes. The coordination service may comprise one or more orchestration engines such as Kubernetes, Apache Mesos, or a proprietary service, which performs one or more tasks for service deployment, fault tolerance, auto-scaling, and lifecycle management. The distributed computing architecture may include a data transport layer to facilitate communication among the computing nodes. The data transport layer may utilize standard network protocols including TCP/IP, HTTP/HTTPS, WebSocket, gRPC, or a message queue-based middleware (e.g., Apache Kafka, RabbitMQ, or MQTT). Additionally, each computing node may execute one or more functional components of system 1100, which may be implemented as microservices or modular application components. In certain embodiments, a first functional component (e.g., data communication, preprocessing) may reside on an edge computing node, while a second functional component (e.g., analytics or model inference) may be deployed on a backend server or cloud instance. The distributed computing architecture may operate within a hybrid cloud environment, combining on-premises infrastructure with public or private cloud resources.

In at least one embodiment, system 1100 includes one or more data sources (e.g., data source 1104A, data source 1104B, data source 1104N), data aggregator 1108, data transformer 1110, and interface handler 1120. Data aggregator 1108 may refer to a component configured to collect, consolidate, and normalize data from multiple heterogeneous data sources (e.g., data source 1104A, data source 1104B, data source 1104N). Data aggregator 1108 may include one or more of software, hardware, and/or circuitry arranged to perform the function described. Data aggregator 1108 may include one or more circuits that form part of a larger system (e.g., an integrated circuit (IC), system on-chip (SoC), central processing unit (CPU), data processing unit (DPU), distributed computing architecture, etc.).

In various examples, unless explicitly or implicitly noted otherwise, terms such as “software” described herein may include one or more of application software, system software, firmware middleware, device drivers, embedded software, virtual machine code, operating system components, scripts (e.g., Python), extensions, plug-ins, runtime environments, mobile applications, cloud-based services or functions, software containers, microservices, artificial intelligence models executed as software modules, network management software, web-based software or APIs, compiled code or bytecode, interpreted code, executable software instructions stored in memory, bootloaders or startup sequences, software development kits (SDKs), libraries or shared objects, among others.

In some examples, unless explicitly or implicitly noted otherwise, terms such as “hardware” described herein may include one or more of microprocessors, microcontrollers, application-specific integrated circuits (ASICs), field-programmable gate arrays (FPGAs), digital signals processors (DSPs), SoC components, GPUs, CPUs, memory devices (e.g., RAM, ROM, flash, EEPROM), programmable logic devices, embedded controllers, network interface cards (NICs), bus controllers, peripheral interface controllers, custom circuitry, hardware accelerators, sensors, communication interfaces, or security modules, among others.

In other examples, data aggregator 1108 operates across a wide range of data environments, including structured, semi-structured, and unstructured data formats, and may interact with both local and remote sources. The data aggregator 1108 may retrieve data from various sources such as relational databases, NoSQL systems, file-based repositories, third-party APIs, data lakes, or real-time data streams. These data sources may differ in schema, access protocols, update frequency, and authentication requirements. Data aggregator 1108 may include a set of pluggable connectors or adapters, each configured to interface with a particular data source or format. These connectors may abstract source-specific logic, allowing data aggregator 1108 to maintain a consistent interface while integrating disparate data types.

Data aggregator 1108 may also extract and maintain metadata associated with each data source and its corresponding datasets. This metadata may include information such as source identity, update frequency, access credentials, data lineage, field definitions, and last retrieval timestamp. Also, data aggregator 1108 may be capable of operating in either a synchronous or asynchronous mode. In synchronous mode, data aggregator 1108 may query source systems in real time, retrieving data on demand in response to user or system requests. In asynchronous mode, data aggregator 1108 may be configured to perform scheduled data pulls (e.g., periodic, aperiodic), incremental updates, or event-driven refreshes. Some implementations may support change-data-capture techniques to efficiently identify and ingest only modified records. In some examples, data aggregator 1108 may include data aggregator 208 illustrated in FIG. 2 or data aggregator 308 illustrated in FIG. 3. Once the data aggregator 1108 obtains such data, it may send those data to data transformer 1110.

In at least one embodiment, data transformer 1110 refers to a component configured to receive data from data aggregator 1108 and apply one or more transformation operations to prepare the data for analysis, visualization, modeling, or storage. Data transformer 1110 may include one or more of software, hardware, and/or circuitry arranged to perform the function described. Data transformer 1110 may include one or more circuits that form part of a larger system (e.g., an IC, SoC, CPU, DPU, distributed computing architecture, etc.). The data transformer 1110 may operate on data originating from heterogeneous sources and may be designed to convert, align, and structure such data into a consistent and usable format.

In some examples, upon receiving input from the data aggregator 1108, data transformer 1110 performs normalization operations to reconcile differences in schema, data types, formats, and structure. Normalization may include actions such as converting data types (e.g., string to date), normalizing field names, flattening nested data structures (e.g., JSON or XML), resolving key mismatches, and enforcing consistent units of measure or naming conventions across datasets.

In various examples, data transformer 1110 normalizes incoming data by consolidating multiple input tables, each potentially corresponding to a different data source or schema, into a single unified output table. These input tables may differ in structure, naming conventions, column types, and cardinality. Data transformer 1110 may identify and reconcile these differences through schema matching, data type coercion, and relational alignment techniques.

In other examples, data transformer 1110 is configured to normalize input datasets by reconciling differing representations of application traits, resource usage metrics, and process taxonomies. The input data may originate from various data sources such as monitoring systems, logging platforms, telemetry feeds, or external repositories, each of which may describe system behavior using domain-specific schemas or naming convention. Application traits may include metadata such as application name, version, environment (e.g., development, staging, production, etc.), deployment type (e.g., containerized, virtualized, bare-metal, etc.), and any other context. Data transformer 1110 may resolve naming inconsistencies across sources (e.g., “App_Name,” “ApplicationID,” etc.). Where such traits differ in granularity or format, data transformer 1110 may apply transformation rules to map raw values to canonical labels, possibly using controlled vocabularies or pre-defined lookup tables. Resource usage data, such as CPU utilization, memory consumption, disk I/O, and network throughput, may also be reported differently across data sources. Data transformer 1110 may normalize such metrics by converting units, aligning measurement intervals, and mapping vendor- or tool-specific metric names to standard resource categories. Data transformer 1110 may additionally aggregate or interpolate metrics to reconcile sampling differences between data sources.

In at least one embodiment, data transformer 1110 also collects and/or normalizes cost-related data associated with the development, operation, and testing of software applications deployed within the distributed computing infrastructure. This cost data may be obtained from a variety of sources, including but not limited to human resource systems and finance tools (e.g., capitalization records), software asset management systems, and infrastructure monitoring platforms (e.g., cloud service or on-premise resource utilization).

In some examples, data transformer 1110 ingests cost data from these diverse sources and applies normalization logic to reconcile differences in currency, time periods, cost categorization, and data granularity. For example, costs reported monthly in one system and labor costs tracked weekly in another may be converted to a consistent time basis and aggregated accordingly. Additionally, different cost structures, such as fixed vs. variable, capital vs. operational expenditures, may be mapped into a unified cost taxonomy that supports consistent reporting and analysis.

In various examples, data transformer 1110 associates individual cost elements with specific applications, services, or operational processes. This may involve joining cost data with metadata or identifiers from the data aggregator, such as application IDs, deployment environments, tags, or resource labels. In some implementations, the data transformer 1110 resolves ambiguous or shared cost allocations using weighting algorithms, predefined allocation rules, or artificial intelligence models trained to infer likely associations based on historical patterns. Using the normalized and linked cost data, data transformer 1110 may compute a total cost profile for each application or group of applications within the system. This profile may include direct costs, such as infrastructure usage, as well as indirect or amortized costs, such as labor or capital investments. The resulting cost summaries may be output as structured tables or metrics, made available to downstream systems (e.g., interface handler 1120) for visualization, reporting, or decision support.

In at least one embodiment, data transformer 1110 normalizes data from different sources by aggregating various types of data (e.g., cost, resource usage, software application metadata, process taxonomy) based on key identifiers, such as software application identifiers (e.g., name, number) or any other common data points. In various embodiments, data transformer 1110 identifies labor cost data by capturing it at various levels, including different process levels. Data transformer 1110 may identify key data components such as applications, resources, resource rates, and the charges associated with each resource. Data transformer 1110 may receive tables containing application data, resource information, and rate data. Upon connecting to the database, data transformer 1110 may generate a data model to integrate these tables, consolidating cost, resource, and application data into a unified snapshot. Once the transformations are complete, data transformer 1110 may integrate four data sources-resource usage including costs and application metadata-into a single, comprehensive snapshot.

In addition to normalization, data transformer 1110 may perform advanced data wrangling operations such as filtering, grouping, joining, splitting, or aggregating records based on configurable rules or user-defined logic. For example, data transformer 1110 may join datasets based on matching keys, compute new fields from existing values, remove duplicate records, or apply conditional transformations to selected data subsets.

In at least one embodiment, data transformer 1110 applies one or more ML models, neural networks, or any other AI models to the normalized data in order to extract additional insights, perform advanced data enrichment, and support predictive or prescriptive analytics. These models may use structured, semi-structured, or time-series data and may be trained to detect anomalies, trend predictions, classify behaviors, or cluster related entities. Unless explicitly or implicitly noted otherwise, an AI model may refer to a computational system configured to learn patterns or relationships within data through algorithmic processing and iterative optimization, without being explicitly programmed for every specific task. Such models may be trained on labeled or unlabeled datasets to perform tasks such as classification, regression, clustering, dimensionality reduction, analysis, or control. Examples of AI models may include, but are not limited to: (1) Linear models, such as linear regression and logistic regression, which learn linear relationships between inputs and outputs; (2) Decision tree-based models, including random forests and gradient-boosted trees, which use branching structures to partition data and make predictions; (3) Support vector machines, which find optimal hyperplanes for class separation; (4) neural networks, including deep learning models such as convolutional neural networks (CNNs) and recurrent neural networks (RNNs), which are particularly suited for image, audio, and sequential data processing; (5) Clustering models, such as k-means and DBSCAN, which group similar data points based on distance or density metrics; and (6) Probabilistic models, such as Bayesian networks and hidden Markov models, which use statistical inference to model uncertainty and temporal dynamics. These models may be implemented in hardware, software, or combinations thereof, and may operate in real-time or batch processing modes.

In some examples, data transformer 1110 uses anomaly detection models to identify unexpected deviations in cost, resource usage, or operational metrics associated with software applications and append anomaly scores, labels, or metadata to the transformed dataset. Data transformer 1110 may use models, such as time-series regression or neural network-based predictors, to generate future estimates of application-level metrics. These predictions may include expected infrastructure costs. Data transformer 1110 may use models (e.g., k-means, DBSCAN, or hierarchical clustering) to identify relevancy among different types of data, allowing this relevancy to be used for display by interface handler 1120 or for further normalization of data by data transformer 1110.

In some embodiments, interface handler 1120 obtains a request from a first computing device identifying or otherwise referencing a target entity different from an entity currently operating the first computing device. The request may indicate that the system is to determine one or more portions of transformed data, displayed insight objects, summaries, notifications, or recommendation objects that are relevant to the target entity. After the system identifies the relevant portion or object, the interface handler 1120 may present the relevant portion or object to the first computing device and may obtain a response, confirmation, endorsement, or routing instruction indicating whether the relevant portion or object is to be sent to the target entity.

In response to the response, confirmation, endorsement, or routing instruction, the interface handler 1120 may provide the relevant portion or object, or a modified version thereof, to a second computing device associated with the target entity. The modified version may comprise a summary, notification, explanation, recommendation object, or a subset of the underlying transformed data. In some embodiments, the provided information identifies that the routed information is being provided automatically, is endorsed by the entity operating the first computing device or is being provided by the system on behalf of that entity.

In some embodiments, the system determines whether the first entity is authorized to request, endorse, or route information for the target entity based at least in part on an organizational relationship, delegated authority, workflow role, managerial hierarchy, or permission policy. In at least one embodiment, the system determines whether the first entity is authorized to request, endorse, or route information for the target entity before receiving information such as on an organizational relationship, delegated authority, workflow role, managerial hierarchy, or permission policy. The organizational relationship may include analyst-to-manager, subordinate-to-principal, delegate-to-principal, assistant-to-executive, or other enterprise relationships.

In some examples, data transformer 1110 can receive data that is modified by ML models described herein or any other AI models to perform the data transforms described herein. Additionally, data transformer 1110 can use the tag identifying a category of the plurality of categories for each data set described herein to aggregate, normalize, or otherwise transform data to generate a unified data set.

In some examples, data transformer 1110 can generate data representing cost metrics associated with various hierarchical levels of operational or technical processes, such as Level 1 (L1), Level 2 (L2), and Level 3 (L3) processes as described herein. These cost metrics may include, but are not limited to, resource utilization, time expenditure, operational overhead, and expenditures tied to each level of the process hierarchy. In additional embodiments, data transformer 1110 can produce data reflecting cost components attributable to specific software applications. These components may include fees, infrastructure requirements, integration efforts, and maintenance costs. Furthermore, data transformer 1110 can also determine and represent costs associated with discrete portions or modules necessary for the deployment, operation, or support of individual software applications, enabling granular analysis and optimization across the software stack. Additionally, in response to a user request (e.g., via GUI), data transformer 1110 can consolidate normalized data and provide the requested data in a format specified by the user, such as Excel, plain image, or PDF.

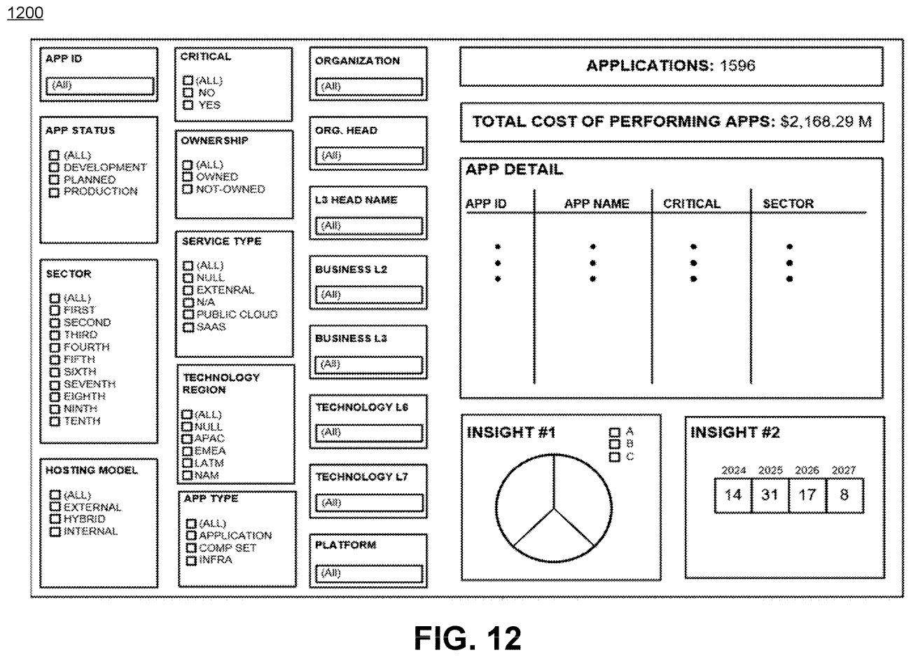

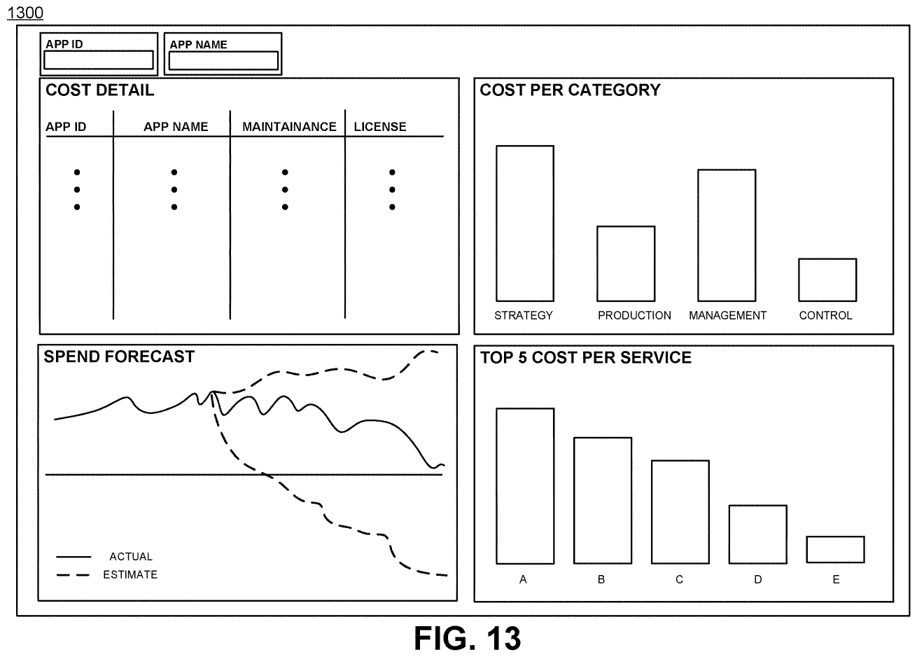

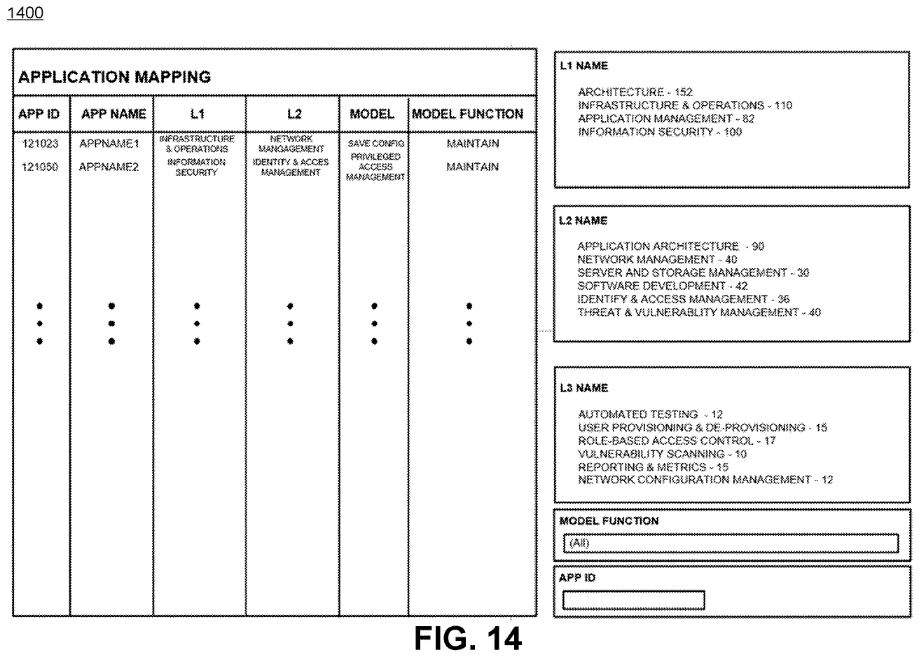

In at least one embodiment, interface handler 1120 refers to a component configured to generate and manage a graphical user interface (GUI) for presenting insights derived from the transformed and normalized data produced by data transformer 1110. Interface handler 1120 may include one or more of software, hardware, and/or circuitry arranged to perform the function described. Interface handler 1120 may include one or more circuits that form part of a larger system (e.g., an IC, SoC, CPU, DPU, distributed computing architecture, etc.). Interface handler 1120 may enable users to access, explore, and interact with operational, performance, and pecuniary information associated with various software applications within a distributed computing infrastructure. The GUI may include dashboard 1200 illustrated in FIG. 12, dashboard 1300 illustrated in FIG. 13, or dashboard 1400 illustrated in FIG. 14.

In various examples, interface handler 1120 organizes and/or renders data associated with each software application, including application attributes, resource usage, process classifications, and cost components. Interface handler 1120 may pull structured data from the data transformer 1110 and arranges it into intuitive visual formats such as tables, charts, graphs, and summary panels. Users can immediately interpret key metrics and drill into specific data points for more detailed analysis.

In some examples, the GUI includes interactive elements that respond to user actions. Users can click, tap, or hover over data elements to reveal additional information, expand grouped data, or filter the view. For example, a user may click on a software application's name to open a detailed view of its cost breakdown or select a specific time range to update visualizations with time-filtered resource usage data. The GUI may support both mouse and touch-based interactions to accommodate different device types.

In other examples, interface handler 1120 adapts the GUI based on user roles or preferences. It may show summaries to users with roles, infrastructure metrics to systems engineers, or aggregated KPIs to executive users. Interface handler 1120 may retrieve user profiles and permissions from an identity service and adjusts the visible interface components accordingly. Additionally, interface handler 1120 may use client-side rendering and asynchronous data fetching. Interface handler 1120 may use technologies such as HTML5, JavaScript, and rendering frameworks like React or Vue.js. Interface handler 1120 may communicate with backend APIs to fetch relevant data on demand and renders dynamic visual elements based on real-time inputs or user selections.

In at least one embodiment, interface handler 1120 interacts with data transformer 1110 to dynamically retrieve and display relevant information in response to user inputs. When a user engages with an interactive element in the graphical user interface-such as clicking on an application name, expanding a cost breakdown panel, or filtering by resource usage-interface handler 1120 may generate a corresponding data request. This request may include parameters such as the selected application identifier, time range, data category, or desired level of detail. The interface handler 1120 may transmit this request to the data transformer 1110 for further processing.

Upon receiving the request, data transformer 1110 may identify the relevant subset of transformed or raw data from prior aggregation pipelines. If the requested data is not yet in a suitable format or level of granularity, data transformer 1110 may apply additional transformation operations—such as filtering, joining, grouping, or re-normalization—to modify the dataset to the specific context of the request. Data transformer 1110 then can return the resulting data to the interface handler 1120, which uses it to update the GUI.

In at least one embodiment, interface handler 1120 can render a wide variety of visual representations to communicate application-level insights to users through the graphical user interface. These visualizations allow users to quickly interpret complex datasets and identify trends, anomalies, or relationships across different software applications and system dimensions. Interface handler 1120 selects and renders appropriate visual elements based on the structure of the underlying data and the nature of the user request.

In some examples, interface handler 1120 generates time-series graphs to display historical trends, such as CPU/accelerator usage, memory consumption, or cost changes over a specified period. These graphs may allow users to observe performance fluctuations, usage patterns, or cost variations across time and compare multiple applications or resources within the same visual frame. Interface handler 1120 may use bar charts, column charts, or stacked graphs to represent aggregated data categories. For example, it can display application-level cost distributions broken down by type (e.g., infrastructure).

Interface handler 1120 may also present data using pie charts or donut charts when visualizing part-to-whole relationships. For example, a pie chart may illustrate how total infrastructure cost is divided among multiple software applications. Heatmaps and matrix views may be used to display multi-dimensional metrics, such as performance scores across applications and environments, enabling users to quickly identify high-risk or high-cost areas. For geographic data or infrastructure deployed across different regions, Interface handler 1120 may display information on a map visualization. Interface handler 1120 may support table views with expandable rows, sortable columns, and embedded visual indicators such as spark lines or color-coded tags. Each visualization may include interactive features such as hover tooltips, zooming, filtering, and drill-down capabilities.

In some embodiments, interface handler 1120 renders a notification, summary, or recommendation object derived from transformed data and/or a displayed insight object. The notification, summary, or recommendation object may identify a forecasted event, threshold breach, anomaly, upcoming obligation, imbalance, or other condition determined from normalized enterprise data. The notification, summary, or recommendation object may further identify a proposed action responsive to the condition, such as transferring or allocating a resource, escalating a task, covering an upcoming obligation, or otherwise initiating a next-best action workflow.

In some embodiments, the notification, summary, or recommendation object includes an affordance to display supporting information, such as a “See insights” control, a deep link to one or more underlying dashboard views, supporting transformed data, one or more contributing data points, a rationale summary, or a confidence measure. The system may thereby enable a recipient entity to inspect why a particular displayed insight object or recommendation object was selected, which underlying data contributed to the recommendation, and whether the recommendation was routed automatically or on behalf of another entity.

In some embodiments, a recommendation object includes a structured data object comprising a summary message, a reference to one or more supporting insight objects, a proposed action, and one or more metadata attributes identifying a source entity, a target entity, or provenance information associated with the recommendation.

In some embodiments, the system maintains workflow states and/or provenance metadata associated with one or more displayed insight objects, summaries, notifications, or recommendation objects. The workflow states may identify that an item is suggested, selected, awaiting confirmation, sent, delivered, viewed, acknowledged, dismissed, or acted upon. The provenance metadata may identify one or more of the entity originating a request, the entity endorsing a request, the target entity, a time, a source interface, or an “on behalf of” status.

Interface handler 1120 may incorporate ML models, neural networks, or any other AI models to enhance the visualization and interpretation of data presented via GUI. By leveraging predictive, classification, or clustering models, interface handler 1120 can generate visualizations that go beyond static reporting and instead highlight patterns, correlations, and actionable insights derived from the transformed dataset.

In some examples, interface handler 1120 generates dashboards that correspond to software application metadata, resource usage, and/or process taxonomy. Interface handler 1120 may generate custom dashboards based on user request. Interface handler 1120 can generate dashboards based on historical data (e.g., the number of requests made for a particular type of data), or the determination can be made by one or more artificial intelligence models described herein.

In at least one embodiment, data source 1104A can include various types of application metadata. Software application metadata may include a diverse array of components essential for the effective management and categorization of software applications and tech products. Software application metadata may include application-specific details such as application type, service type, function type, and application status. Application metadata may include operational information, such as operational segment, tech segment, sector, and region. Software application metadata may include org head, org name, application manager, and primary operational information owner. Application metadata may include hosting model, product platform, ownership model, operational criticality, target retirement date, end of vendor support, and buy-hold-sell strategies. In some examples, data source 1104A can be a group of different data sources and different types of application metadata may belong to each data source within the group.

In at least one embodiment, data source 1104B includes resource information. The resource information may include allocations related to labor. The resource information may include amortization and capitalization. The resource information may include software costs, covering software purchases and maintenance. The resource information may include infrastructure costs, specifically non-consumable charges for network, data center, and storage. The resource information may include resource allocations such as outreach, hardware and software leases, and legal fees. In some examples, data source 1104A can be a group of different data sources and different types of application metadata may belong to each data source within the group. For example, the resource information may originate from infrastructure monitoring tools, system logs, telemetry agents, cloud provider APIs, or embedded instrumentation within the software applications themselves.

In some examples, the resource information includes CPU usage, memory consumption, disk I/O, network throughput, storage allocation, thread or process counts, and/or GPU utilization where applicable. Additional resource metrics may capture environmental factors such as power consumption, thermal load, and uptime statistics. The resource information may include deployment-specific information, such as container or virtual machine allocations, node residency, cluster membership, and scheduling priority. The resource information may include derived metrics, such as average utilization over time, peak usage windows, scaling frequency, or efficiency scores that relate resource usage to application output or service levels. The resource information may include infrastructure costs, which can be broken down into categories such as compute, GPU, virtual CPU, and server. It may also include data points like the volume of resources used, such as the gigabytes of RAM consumed by an application, and the corresponding costs. In some examples, data source 1104B can be a group of different data sources and different types of resource usage data may belong to each data source within the group.

In some examples, the data sources 1104A-N further includes financial-operation data obtained from one or more enterprise financial systems, such as ERP systems, treasury systems, payment systems, banking systems, or reporting systems. Such financial-operation data may include one or more of account balances, payment schedules, vendor obligations, spending by region, liquidity forecasts, payment timeliness measures, bank statement data, fee data, or benchmark data. The data transformer 1110 may normalize such financial-operation data together with other enterprise data and may provide transformed data for display as one or more displayed insight objects, summaries, notifications, or recommendation objects.

By way of example, the transformed data may indicate that forecasted vendor payments associated with a first region, entity, or account are likely to exceed a threshold or available coverage, and the system may generate a recommendation object indicating that a specified amount should be moved, allocated, or otherwise sourced from a second region, entity, or account to cover the projected obligation. The recommendation object may then be routed to a target entity directly, routed on behalf of another entity, or displayed within an embedded ERP or TMS interface together with an explanation link to the underlying insight objects and transformed data.

In at least one embodiment, data source 1104Z includes information of process taxonomy, which may refer to a structured classification of operational procedures based on their functional roles within different software applications installed within a distributed computing infrastructure. Process taxonomy may include application, application function target state, process group L1, parent process L2, process name L3, process function, operational function, among others. Application may refer to applications that are integral to executing processes. Application function target state may refer to the appropriate, maintain, and deprecate states of application functionality, which indicates how applications are managed based on their importance and role in the enterprise, ensuring that appropriate applications are prioritized, while others are maintained or deprecated, as necessary. Process group L1 may refer to highest level of categorization, focusing on the broad service offerings of the enterprise. Parent process L2 may refer to logical order of processes directly underpinning the delivery of the L1 services. Process name L3 may refer to steps needed to complete the L2 process. Process model may refer to a set of defined activities executed in sequence and designed to achieve an entity objective. Process function may refer to a step or activity in a process model that produces process-specific results.

In a distributed computing infrastructure comprising multiple software applications deployed across heterogeneous environments, a structured process taxonomy—organized into hierarchical levels such as L1, L2, and L3—can be employed to systematically identify relationships and generate mappings between these applications. At the L1 level, core operational capabilities can be defined in a manner that is agnostic to specific software implementations. These high-level capabilities serve as anchoring points to group related applications under common operational domains. At the L2 level, end-to-end operational processes can be identified and associated with one or more software applications that contribute to their execution. This can be used for mapping of application roles and responsibilities within broader operations. At the L3 level, fine-grained subprocesses or software operations can be enumerated and mapped directly to specific modules, services, or APIs implemented within each application. By analyzing these mappings, dependencies and integration points between applications can be precisely identified. This hierarchical approach can enable the discovery of shared processes, redundant functionalities, and missing capabilities across the distributed system. Furthermore, it can facilitate the orchestration of composite operations that span multiple applications, by aligning subprocesses according to their logical position within the taxonomy. The process taxonomy can be used to map not only the software application itself but also various types of attributes, resource usage (e.g., costs), etc.

In at least one embodiment, different data sources can store this information in separate data structures (e.g., tables). For example, software application metadata from data source 1104A can be stored in one or more first tables. Various types of resource usage data from data source 1104B can correspond to each table. Additionally, process taxonomy information can be stored in a separate table. As a result, data transformer 1110 can transform at least one of the data structures to generate a single data structure that stores all the information. Aggregation of the tables can be based on software application ID or names. In some examples, aggregation of the tables can be based on criteria determined by user, use cases, heuristics, and any other artificial intelligence models described herein.

In at least one embodiment, the generated dashboard can consolidate all relevant data, allowing entities (e.g., architecture team) to efficiently analyze and compare cost benefits of software applications without needing to consult individual source owners. This streamlined process can significantly enhance entities' ability to make informed decisions. The interactive capabilities of the dashboard can allow users to manipulate and analyze data according to their specific needs. Via the dashboard described herein, users can slice and dice the data, selecting various permutations and combinations to view the information in a manner that best suits their objectives.

FIG. 12 illustrates an example dashboard 1200 to provide insights, in accordance with an embodiment. Dashboard 1200 can provide comprehensive insights into application performance and management. Dashboard 1200 can serve as a centralized platform for monitoring various application metrics and statuses. Dashboard 1200 can display aggregated metrics at the top, including the total number of software applications installed within one or more distributed computing infrastructures, and/or the total cost for performing the software applications.

In some examples, users can refine the displayed data using filters on the left side of dashboard 1200. These filters include options for App ID, Hosting Model, Application Status, Sector, Ownership Model, Service Type, Organization, Org. Head, Technology Region, Level3 Head Name, L2, L3, Application Type, Technology L6, Technology L7, and CTC Platform. These filters can allow a user to create customized views according to specific criteria.

In various examples, the central portion of dashboard 1200 can provide detailed insights into CSIs and CTCs. The “App Detail” section can list software applications by App ID, App Name, APM B-H-S, PBIO Name, Criticality, Sector, Technology, and Application Status. This section can provide granular information about each application, including its current status (Buy, Hold, Sell), impact, and technological specifications. In other examples, dashboard 1200 can provide pie charts that visually represent information related to the software applications.

FIG. 13 illustrates an example dashboard 1300 to provide insights related to resource usage, in accordance with an embodiment. Dashboard 1300 may include detailed overview of resource usage (e.g., total cost of ownership) for various applications. Dashboard 1300 may include a detailed table labeled “Cost Detail,” which lists applications by App ID and App Name. This table may provide granular pecuniary data, including cash labor, labor-related costs, capitalization, amortization, net labor, and software application expenses.

Additionally, dashboard 1300 may include bar charts and line graphs, which may include both actual and estimated figures. Users can refine the displayed data using filters located at the top right of the dashboard. These filters can include options for App ID and App Name, enabling customization according to specific criteria.

FIG. 14 illustrates an example dashboard 1400 to provide insights related to functions to map software applications, in accordance with an embodiment. Dashboard 1400 may provide a structured overview of application functionalities and their hierarchical categorization. This interface can act as a tool for organizing and managing applications based on their operational and security attributes. Users can view applications by App ID and App Name, with each application mapped across multiple levels of functionality, including L1, L2, Model, and Model Function. Dashboard 1400 may categorize applications that correspond to different levels, providing a structured overview of application functionalities and their hierarchical categorization. Dashboard 1400 may serve as a tool for organizing and managing applications based on their operational and security attributes. Users can view applications by App ID and App Name, with each application mapped across multiple levels of functionality, including L1, L2, Model, and Model Function.

In various examples, dashboard 1400 can provide detailed lists that include additional context for each level. The L1 Name section can include categories such as Architecture, Infrastructure & Operations, Application Management, and Information Security, with associated numerical identifiers. Similarly, the L2 Name section can list Application Architecture, Network Management, Server and Storage Management, Software Development, Identity & Access Management, and Threat & Vulnerability Management, each with corresponding identifiers. The L3 Name section may offer further granularity, detailing functionalities such as Automated Testing, User Provisioning & De-Provisioning, Role-Based Access Control, Vulnerability Scanning, Reporting & Metrics, and Network Configuration Management.

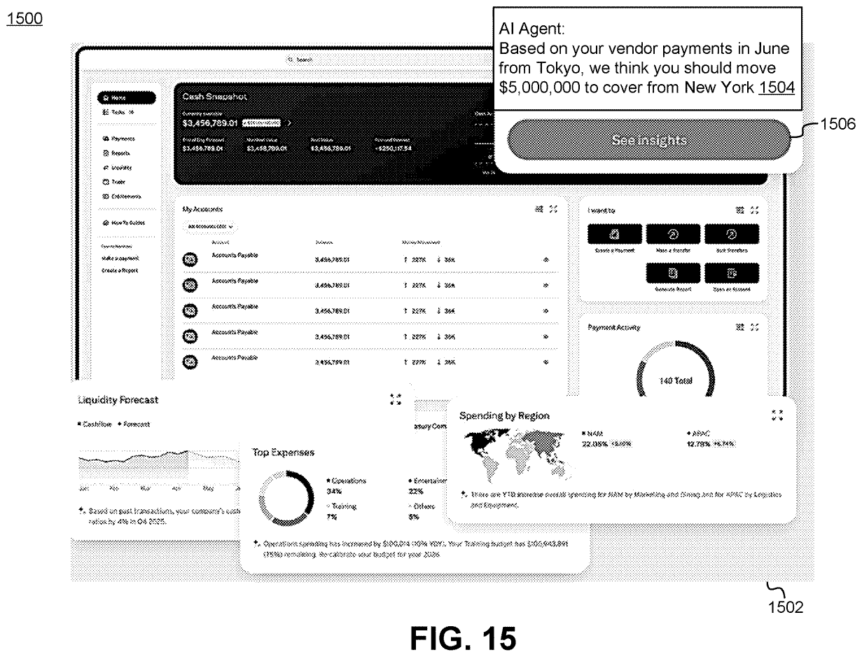

FIG. 15 illustrates an example interface 1502 for displaying one or more insight objects generated from normalized enterprise data. Interface 1502 may be rendered by interface handler 1120 executing on a computing system such as system 1100 and may be presented on a display device associated with a computing device operated by an entity. Interface 1502 may be embedded within, launched from, or otherwise integrated with an enterprise workflow application, such as an enterprise resource planning (ERP) system, treasury management system (TMS), enterprise portal, or other system of record, thereby allowing the entity to access generated insights without leaving the workflow environment.

In some embodiments, interface 1502 includes a recommendation panel associated with recommendation object 1504, which may present a summary message generated by the computing system indicating a detected condition or proposed action derived from transformed enterprise data. The recommendation panel may be displayed in association with one or more displayed insight objects rendered within the interface, such as charts, metric panels, alerts, or dashboard tiles representing operational metrics or aggregated enterprise data. As illustrated in FIG. 15, the displayed insight objects may be arranged within a dashboard region of interface 1502 and may correspond to graphical panels generated by output visualizer 522 based on transformed data received from data transformer 1110. Interface 1502 may further include an interactive control 1506, such as a “See insights” affordance, that allows an entity to access one or more underlying insight objects or supporting dashboard views associated with recommendation object 1504.

In at least one embodiment, data aggregator 1108 obtains data from one or more data sources 1104A-N, including metadata, resource usage data, application activity data, or other operational data associated with software applications deployed in a distributed computing infrastructure. Data transformer 1110 may normalize and transform the obtained data to generate transformed enterprise data that may be suitable for analytics, machine learning inference, or insight generation. The computing system may then generate one or more insight objects from the transformed enterprise data. The insight objects may include dashboard cards, charts, alerts, metrics, summaries, or other graphical or textual elements that represent conditions, trends, forecasts, anomalies, or operational metrics determined from the normalized data.

Interface 1502 may display a plurality of such insight objects within a dashboard region of the interface. Each displayed insight object may represent a visualization or summary generated from the transformed enterprise data and may be produced using one or more evaluation models 524A-N, machine learning models, statistical models, or other analytical processes executing within the computing system. In some embodiments, the computing system generates the displayed insight objects in response to user interaction, scheduled evaluation, threshold detection, anomaly detection, or prediction outputs generated by the machine learning models described herein.

In some embodiments, interface 1502 further presents a notification object or recommendation object 1504 generated from one or more of the displayed insight objects. Recommendation object 1504 may identify a condition derived from the transformed enterprise data and may further identify a proposed action responsive to the condition. The recommendation object may be generated automatically by the computing system or may be generated based on an instruction, query, or routing request originating from another computing device associated with a different entity.

In some embodiments, interface 1502 is rendered within a user interface of an enterprise workflow application, such as an ERP system, TMS, or other system of record, and may therefore appear within a workflow interface associated with operational tasks, transaction monitoring, resource management, or enterprise analytics. The computing system may cause interface handler 1120 to render recommendation object 1504, interactive control 1506, and the plurality of displayed insight objects together within the workflow interface so that an entity can inspect generated insights and underlying data without navigating away from the workflow application.

Interface 1502 may also present an interactive control, such as a “See insights” affordance, which may enable an entity to access supporting information associated with the recommendation object or notification. Selection of the affordance may cause interface handler 1120 to retrieve and display one or more supporting insight objects, underlying dashboard views, or portions of the transformed enterprise data that contributed to the generation of the recommendation object. In this manner, the interface may provide a drill-down mechanism that enables the entity to inspect the rationale, supporting data points, or contextual information associated with the generated recommendation.

In some embodiments, selection of interactive control 1506 causes the computing system to retrieve one or more supporting insight objects corresponding to recommendation object 1504 and to render those supporting insight objects within interface 1502 or within a linked dashboard view. The supporting insight objects may include charts, metrics, historical trends, or transformed data elements that contributed to the generation of recommendation object 1504. The computing system may thereby allow an entity to inspect the supporting data and reasoning associated with the recommendation object and to determine whether the recommendation object should be accepted, endorsed, routed, or dismissed.

In some embodiments, interface handler 1120 dynamically updates the displayed insight objects based on additional transformed data received from data transformer 1110, user interactions received from the computing device, or updates to workflow state information associated with one or more insight objects. The interface may therefore provide a continuously updated visualization environment that reflects conditions detected from the enterprise data and that supports routing, confirmation, or endorsement operations associated with recommendation objects and insight objects described herein.

In this manner, interface 1502 may provide a graphical environment in which insight objects derived from normalized enterprise data can be generated, displayed, inspected, and acted upon within an integrated workflow application while the underlying data transformation, model evaluation, and insight generation processes are performed by the computing system components described in connection with FIGS. 11-13.

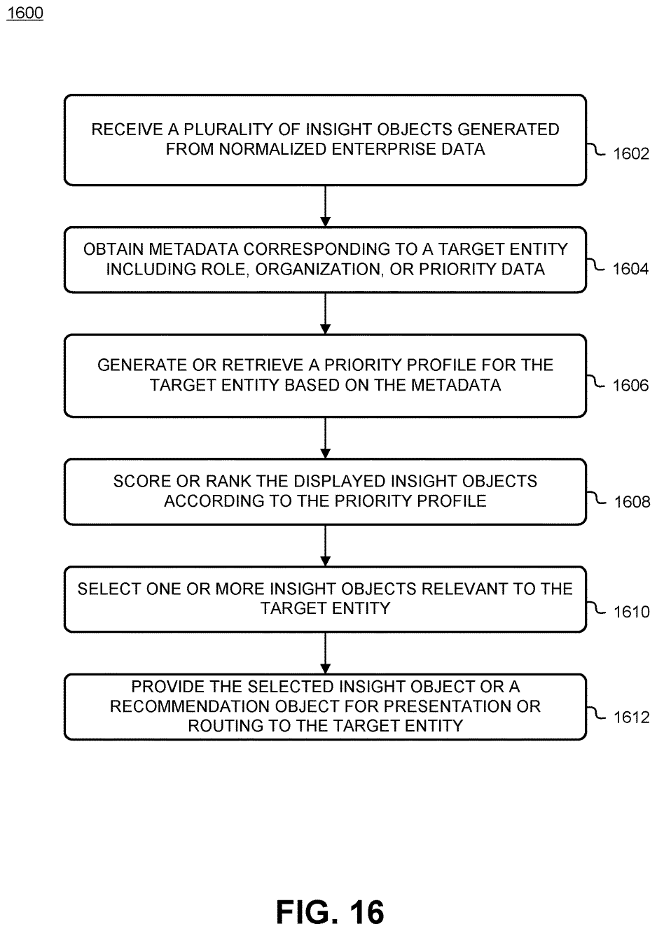

FIG. 16 illustrates a process performed by one or more processors to determine and route one or more insight objects that are relevant to a target entity. In some embodiments, the one or more processors executes instructions associated with data processing system 202, data processing system 302, system 1100, or another computing system described herein. The operations of process 1600 may enable the computing system to determine which insight objects generated from transformed enterprise data should be surfaced, summarized, or routed for a target entity based at least in part on metadata, role information, organizational relationships, priorities, thresholds, or historical interactions associated with that target entity.

In some embodiments, one or more processors begin process 1600 by performing operation 1602 to receive a plurality of insight objects generated from normalized enterprise data. The one or more processors may obtain the plurality of insight objects from a graphical user interface, dashboard view, or other interface generated by interface handler 1120. The insight objects may correspond to charts, metrics, alerts, summaries, tiles, cards, or other visual elements generated from transformed enterprise data produced by data transformer 1110. The one or more processors may obtain the normalized enterprise data from one or more data sources 1104A-N via data aggregator 1108 and may generate the plurality of insight objects using one or more evaluation models, machine learning models, or analytical models operating within system 1100.

In some embodiments, one or more processors continue process 1600 by performing operation 1604 to obtain metadata corresponding to a target entity. The one or more processors may retrieve the metadata from a data store, directory service, user profile repository, or enterprise identity system. The metadata may include one or more attributes associated with the target entity, such as a role, title, organizational hierarchy information, organizational responsibility, geography, threshold subscription, workflow responsibility, delegated authority, permissions, historical interaction with previously displayed insight objects, or workflow responsibilities associated with the target entity. The one or more processors may associate the metadata with the target entity in order to determine how the plurality of insight objects should be evaluated with respect to the target entity.

In some embodiments, one or more processors continue process 1600 by performing operation 1606 to generate or retrieve a priority profile for the target entity based on the metadata. The one or more processors may construct the priority profile using explicit configuration data, stored user preferences, inferred behavioral patterns, or machine learning predictions derived from historical interaction data. The priority profile may identify categories of insight objects, thresholds, operational domains, workflow responsibilities, or other contextual factors that indicate which types of insight objects the target entity is likely to prioritize. The one or more processors may store the generated priority profile in association with the target entity for use in subsequent evaluation or ranking operations.

In some embodiments, one or more processors continue process 1600 by performing operation 1608 to score or rank the plurality of displayed insight objects according to the priority profile. The one or more processors may evaluate each insight object by comparing attributes associated with the insight object to attributes defined in the priority profile. For example, the one or more processors may determine whether an insight object corresponds to a threshold, category, region, operational responsibility, or workflow domain identified in the priority profile. The one or more processors may then compute a relevance score, ranking value, or selection probability for each insight object using one or more scoring models, machine learning models, heuristic ranking functions, or statistical evaluation processes. In cases where a threshold is met, the insight object may automatically qualify for forwarding to the target entity.

In some embodiments, one or more processors continue process 1600 by performing operation 1610 to select one or more insight objects relevant to the target entity. The one or more processors may select the insight objects based on the computed relevance scores, ranking values, or selection probabilities generated during the scoring operation. The one or more processors may select the insight objects by identifying insight objects whose scores exceed a threshold, whose ranking positions fall within a predetermined range, or whose predicted relevance exceeds a probability threshold. The one or more processors may identify the selected insight objects as candidate insight objects for presentation, summarization, notification generation, or routing to the target entity.

In some embodiments, one or more processors continue process 1600 by performing operation 1612 to provide the selected insight object or a recommendation object for presentation or routing to the target entity. The one or more processors may generate the recommendation object from the selected insight object by summarizing the insight object, extracting supporting transformed data, or generating a proposed action responsive to a detected condition represented by the insight object. The one or more processors may then provide the selected insight object or recommendation object for display within a graphical user interface, may transmit the object to a computing device associated with the target entity, or may provide the object to an interface associated with a first entity that may review the object and confirm or endorse routing of the object to the target entity.

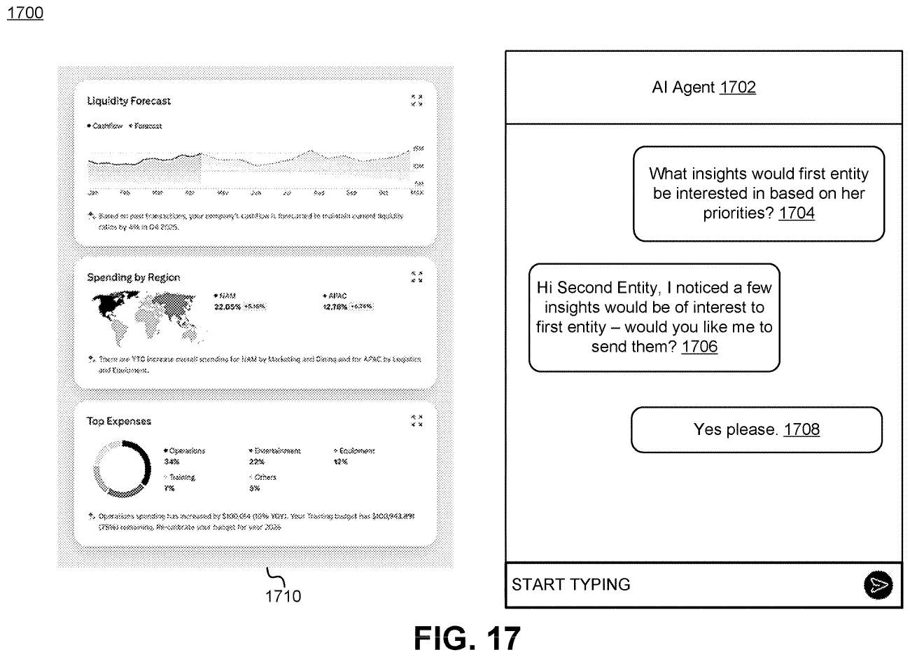

FIG. 17 illustrates an example interface 1700 in which one or more processors present a routed insight or recommendation interaction associated with a target entity. In some embodiments, one or more processors executing within data processing system 202, system 1100, or another computing system described herein may generate one or more displayed insight objects from normalized enterprise data obtained from data sources 1104A-N and transformed by data transformer 1110. The one or more processors may cause interface handler 1120 to render the displayed insight objects within a graphical user interface together with a conversational interface associated with an artificial intelligence agent 1702. The conversational interface may present one or more queries, responses, or prompts (e.g., messages 1704, 1706, and 1708) that enable an entity operating a first computing device to identify a target entity, determine which displayed insight objects may be relevant to that target entity, and request routing of one or more of the displayed insight objects to the target entity. A first computing device may identify a target entity other than by being designated by the initial user. For example, a first computing device may identify a target entity based on shared metadata with an insight object. In another example, the first computing device may identify a target entity that is designated within a database when the insight object meets a specified relevance score. This relevance score may be calculated using measurements of predefined characteristics of the insight object, and those measurements may be weighted.

As illustrated in FIG. 17, the conversational interface associated with artificial intelligence agent 1702 may display a sequence of messages or prompts, such as query message 1704, response message 1706, and confirmation prompt 1708. Query message 1704 may request identification of insight objects that may be relevant to a target entity. Response message 1706 may present a proposed recommendation or summary derived from one or more displayed insight objects generated from transformed enterprise data. Confirmation prompt 1708 may request authorization to route the proposed recommendation object or notification to the target entity.

In some embodiments, the one or more processors evaluate metadata associated with the target entity, generate or retrieve a priority profile associated with the target entity, and identify one or more displayed insight objects that are likely to be relevant to the target entity based at least in part on the priority profile. The one or more processors may then present a prompt to the entity operating the first computing device indicating that one or more identified insight objects may be of interest to the target entity and requesting confirmation or routing authorization. In response to receiving a confirmation or routing instruction, the one or more processors may generate a notification object or recommendation object derived from the selected insight object and may transmit the notification object or recommendation object to a second computing device associated with the target entity. In some embodiments, the one or more processors associate the routed notification object or recommendation object with provenance metadata identifying one or more of an originating entity, an endorsing entity, a time, a source interface, or an “on behalf of” designation. The one or more processors may further update one or more workflow states associated with the routed notification object or recommendation object, such as suggested, selected, awaiting confirmation, sent, delivered, viewed, acknowledged, dismissed, or acted upon. In this manner, the one or more processors may enable an entity operating a first computing device to evaluate displayed insight objects generated from transformed enterprise data, confirm routing of one or more of the displayed insight objects for another entity, and cause a corresponding notification object or recommendation object to be delivered to a computing device associated with the target entity together with provenance information and workflow state information maintained by the computing system.

In some embodiments, the routed notification object or recommendation object generated in response to confirmation prompt 1708 may include provenance metadata indicating that the routed information is being delivered on behalf of the entity operating the first computing device. The provenance metadata may identify the originating entity, an endorsing entity, a routing time, or a source interface associated with the routing action. The computing system may present such provenance information within the conversational interface or within a notification interface rendered on the computing device associated with the target entity so that the recipient entity can determine the source and context of the routed recommendation object.

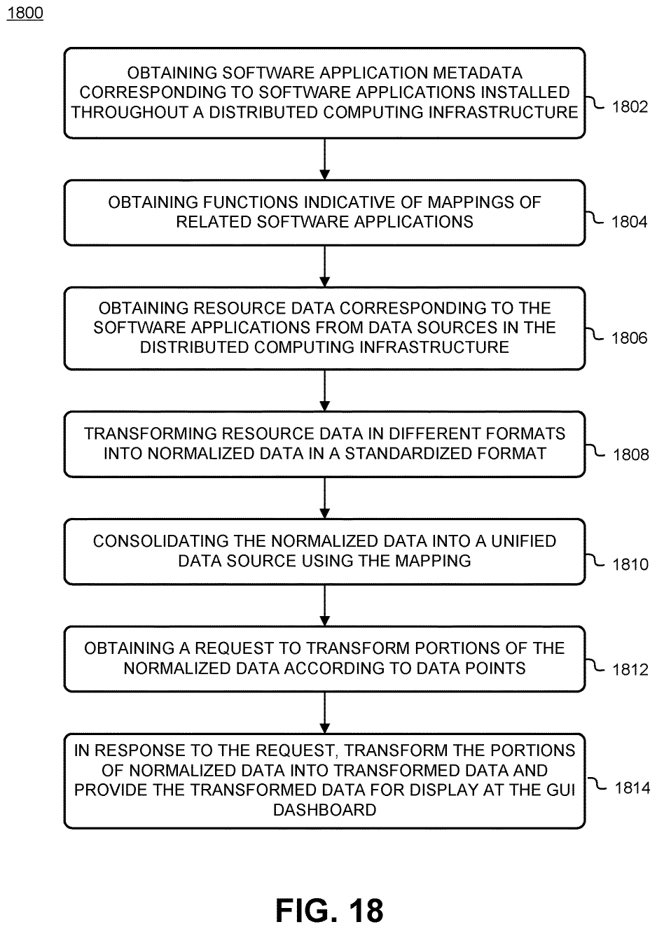

FIG. 18 illustrates a flowchart that illustrates an example process 1800 of generating insights, in accordance with an embodiment. Some or all of the process 1800 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 1800 may be performed by any suitable system (e.g., data processing system 202, data aggregator 208, data transformer 210, tag generator 212, feature evaluator 214, model manager 216, model applier 218, interface handler 220, output visualizer 222, evaluation models 224A-N, user interface 226 illustrated in FIG. 2, data processing system 302, data aggregator 308, data transformer 310, tag generator 312, interface handler 320, user interface 326 illustrated in FIG. 3, data processing system 402, feature evaluator 414, model manager 416, model applier 418, evaluation models 424A-N illustrated in FIG. 4, data processing system 502, feature evaluator 514, model applier 518, interface handler 520, output visualizer 522, evaluation models 524A-N, user interface 526 illustrated in FIG. 5, data aggregator 1108, data transformer 1110, interface handler 1120 illustrated in FIG. 11). In some examples, some or all of process 1800 can be performed by artificial intelligence models described herein.

At block 1802, process 1800 may include obtaining software application metadata corresponding to software applications installed throughout a distributed computing infrastructure. In some examples, there could be more than one distributed computing infrastructure. At block 1804, process 1800 may further include obtaining functions, processes, or any other objectives related to the software applications and/or distributed computing infrastructure indicative of mappings of related software applications. At block 1806, process 1800 may further include obtaining resource data corresponding to the software applications from data sources in the distributed computing infrastructure.

At block 1808, process 1800 may further include transforming resource data in different formats into normalized data in a standardized format. The transformation can be done by at least identifying key identifiers that correspond to different types of data or common data points, which may include software application identifiers. The transformation may include calculating costs or any other resource usage associated with software applications so that total cost of running one or more software applications can be computed. At block 1810, process 1800 may further include consolidating the normalized data into a unified data source using the mapping. At block 1812, process 1800 may further include obtaining a request to transform portions of the normalized data according to data points. At block 1814, process 1800 may further include transforming the portions of normalized data into transformed data and providing the transformed data for display at the GUI dashboard. The GUI dashboard may include at least one of: dashboard 1200 illustrated in FIG. 12, dashboard 1300 illustrated in FIG. 13, or dashboard 1400 illustrated in FIG. 14. In some examples, the GUI dashboard may indicate a greater number of software applications performing a smaller number of functions or processes. This could suggest redundancy or duplication within the distributed computing infrastructure.

Note that one or more of the operations performed in blocks 1802-1814 may be performed in various orders and combinations, including in parallel. Some or all of the process 1800 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). Some of blocks 1802-1814 can be performed prior to, concurrently with, or as a result of any of performing at least one of blocks 605, 610, 615, 620, 625, 630, 635, or 640 illustrated in FIG. 6. Some of blocks 1802-1814 can be performed to generate example interfaces, such as dashboard 1200 illustrated in FIG. 12, dashboard 1300 illustrated in FIG. 13, or dashboard 1400 illustrated in FIG. 14.

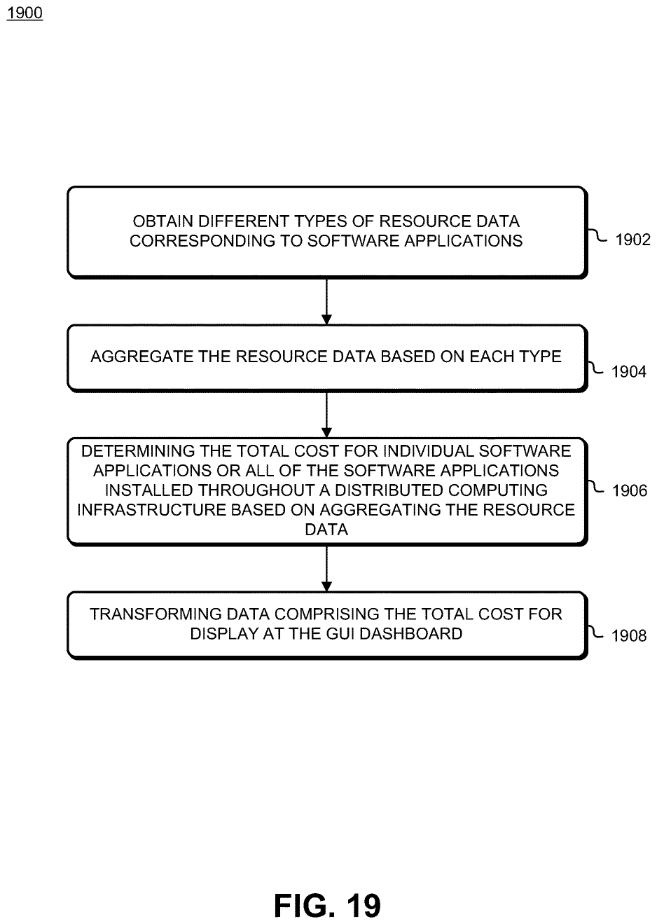

FIG. 19 illustrates another flowchart that illustrates an example process 1900 of aggregating resource usage data to generate insights, in accordance with at least one embodiment. Some or all of the process 1900 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 1900 may be performed by any suitable system (e.g., data processing system 202, data aggregator 208, data transformer 210, tag generator 212, feature evaluator 214, model manager 216, model applier 218, interface handler 220, output visualizer 222, evaluation models 224A-N, user interface 226 illustrated in FIG. 2, data processing system 302, data aggregator 308, data transformer 310, tag generator 312, interface handler 320, user interface 326 illustrated in FIG. 3, data processing system 402, feature evaluator 414, model manager 416, model applier 418, evaluation models 424A-N illustrated in FIG. 4, data processing system 502, feature evaluator 514, model applier 518, interface handler 520, output visualizer 522, evaluation models 524A-N, user interface 526 illustrated in FIG. 5, data aggregator 1108, data transformer 1110, interface handler 1120 illustrated in FIG. 11). In some examples, some or all of process 1800 can be performed by artificial intelligence models described herein.

At block 1902, process 1900 may include obtaining different types of resource data corresponding to software applications. At block 1904, process 1900 may further include aggregating the resource data based on each type of the resource data. The type may include different hierarchies to which the resource data belongs.

At block 1906, process 1900 may further include determining the total cost for individual software applications or all of the software applications installed throughout a distributed computing infrastructure based on aggregating the resource data. There can be more than one distributed computing infrastructure. In some examples, the total cost for a subset of software applications can be determined. At block 1908, process 1900 may further include transforming data comprising the total cost for display at the GUI dashboard. The GUI dashboard may include at least one of: dashboard 1200 illustrated in FIG. 12, dashboard 1300 illustrated in FIG. 13, or dashboard 1400 illustrated in FIG. 14.

Note that one or more of the operations performed in blocks 1902-1906 may be performed in various orders and combinations, including in parallel. Some or all of the process 1900 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). Some of blocks 1902-1906 can be performed prior to, concurrently with, or as a result of any of performing at least one of blocks 605, 610, 615, 620, 625, 630, 635, or 640 illustrated in FIG. 6. Some of blocks 1902-1906 can be performed to generate example interfaces, such as dashboard 1200 illustrated in FIG. 12, dashboard 1300 illustrated in FIG. 13, or dashboard 1400 illustrated in FIG. 14.

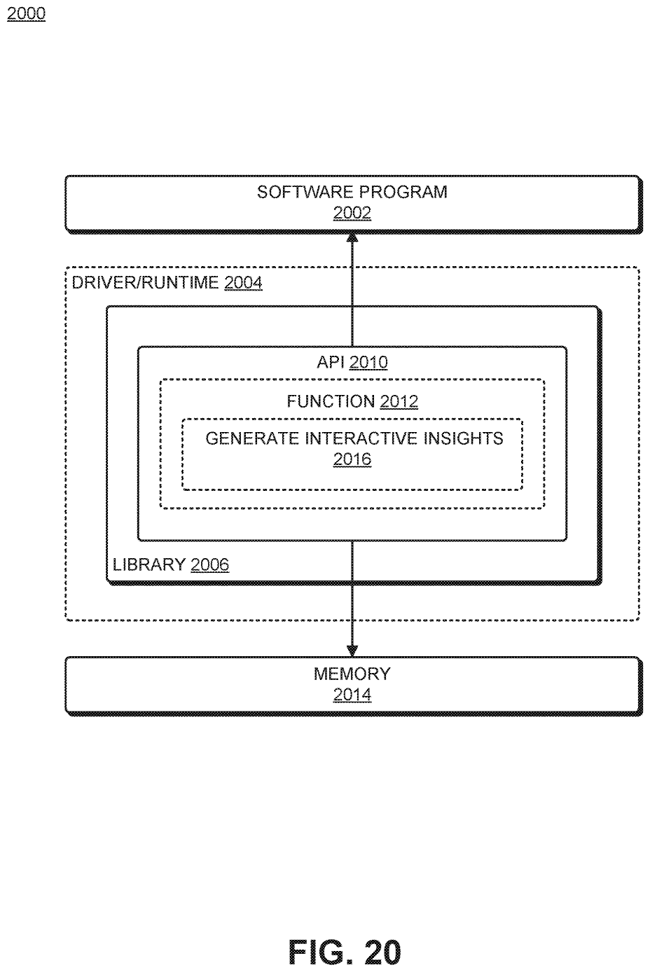

FIG. 20 is an exemplary block diagram 2000 that illustrates an example system to generate interactive insights of software applications using an application programming interface (API), in accordance with at least one embodiment. The one or more APIs may be provided to a various computing systems described herein. A software program 2002 can be a software module. A software program 2002 may comprise one or more software modules. One or more APIs 2010 can be sets of software instructions that, if executed, cause one or more processors to perform one or more computational operations. One or more APIs 2010 can be distributed or otherwise provided as a part of one or more libraries 2006, runtimes 2004, drivers 2004, and/or any other grouping of software and/or executable code further described herein. One or more APIs 2010 may perform one or more computational operations in response to invocation by software programs 2002. A software program 2002 can be a collection of software code, commands, instructions, or other sequences of text to instruct a computing device to perform one or more computational operations and/or invoke one or more other sets of instructions, such as APIs 2010 or API functions 2012, to be executed. In some examples, functionality provided by one or more APIs 2010 may include software functions2012.

In at least one embodiment, one or more APIs 2010 are hardware interfaces to one or more circuits to perform one or more computational operations. One or more APIs 2010 described herein are implemented as one or more circuits to perform one or more techniques described above in conjunction with FIGS. 1-20. Additionally, one or more software programs 2002 comprise instructions that, if executed, cause one or more hardware devices and/or circuits to perform one or more techniques described above in conjunction with FIGS. 1-20.

In at least one embodiment, software programs 2002, such as user-implemented software programs, may utilize one or more APIs 2010 to perform various computing operations, such as memory allocation, matrix multiplication, arithmetic operations, or any computing operation performed by any hardware described herein. One or more APIs 2010 can provide a set of callable functions2012, referred to herein as APIs, API functions, and/or functions, that individually perform one or more computing operations. For example, one or more APIs 2010 provide functions2012 to generate interactive insights 2016, which are further described in conjunction with FIGS. 1-5. In some examples, generating interactive insights 2016 includes performing one or more blocks of process 2000 illustrated in FIG. 6, process 1800 illustrated in FIG. 18 and/or process 1900 illustrated in FIG. 19.

In at least one embodiment, an interface can be software instructions that, if executed, provide access to one or more functions 2012 provided by one or more APIs 2010. A software program 2002 may use a local interface when a software developer compiles the one or more software programs 2002 in conjunction with one or more libraries 2006 comprising or otherwise providing access to one or more APIs 2010. One or more software programs 2002 can be compiled statically in conjunction with pre-compiled libraries 2006 or uncompiled source code comprising instructions to perform one or more APIs 2010. One or more software programs 2002 can be compiled dynamically and the one or more software programs 2002 can utilize a linker to link to one or more pre-compiled libraries 2006 comprising one or more APIs 2010.

In at least one embodiment, a software program 2002 uses a remote interface when a software developer executes a software program that utilizes or otherwise communicates with a library 2006 comprising one or more APIs 2010 over a network or other remote communication medium. One or more libraries 2006 comprising one or more APIs 2010 can be performed by a remote computing service, such as a computing resource service provider. In another embodiment, one or more libraries 2006 comprising one or more APIs 2010 can be performed by any other computing host providing the one or more APIs 2010 to one or more software programs 2002.

In at least one embodiment, a processor performing or using one or more software programs 2002 can call, use, perform, or otherwise implement one or more APIs 2010 to allocate and otherwise manage memory 2014 to be used by the software programs 2002. Those software programs 2002 may request a resource management system receive and API call to obtain an access token, identify permissions, and generate the access token using functions2012 provided, in an embodiment, by one or more APIs 2010.

In at least one embodiment, an API 2010 can be provided by driver and/or runtime software 2004. Driver and/or runtime software 2004 may refer to data values and software instructions that, if executed, perform or otherwise facilitate operation of one or more functions2012 of one or more APIs 2010 during load and execution of one or more portions of a software program 2002. Runtime software 2004 may refer to data values and software instructions that, if executed, perform, or otherwise facilitate operation of one or more functions2012 of one or more APIs 2010 during execution of software program 2002.

In at least one embodiment, one or more APIs 2010 provide combined arithmetic operations through driver and/or runtime software 2004, as described above. One or more software programs 2002 may utilize one or more APIs 2010 provided by driver and/or runtime software 604 to allocate or otherwise reserve blocks of memory. One or more APIs 2010 can perform operations performed by different systems (e.g., data processing system 202, data aggregator 208, data transformer 210, tag generator 212, feature evaluator 214, model manager 216, model applier 218, interface handler 220, output visualizer 222, evaluation models 224A-N, user interface 226 illustrated in FIG. 2, data processing system 302, data aggregator 308, data transformer 310, tag generator 312, interface handler 320, user interface 326 illustrated in FIG. 3, data processing system 402, feature evaluator 414, model manager 416, model applier 418, evaluation models 424A-N illustrated in FIG. 4, data processing system 502, feature evaluator 514, model applier 518, interface handler 520, output visualizer 522, evaluation models 524A-N, user interface 526 illustrated in FIG. 5, data aggregator 1108, data transformer 1110, interface handler 1120 illustrated in FIG. 11). In at least one embodiment, an exemplary block diagram 2000 depicts one or more processors comprising one or more circuits to perform one or more software programs 2002 to combine two or more APIs 2010 into a single API.

In at least one embodiment, memory 2014 refers to one or more devices to store data. Memory 2014 may include one or more random access memory (RAM), read-only memory (ROM), flash memory (e.g., USB flash drives, SSD, memory cards), cache memory, hard disk drives (HDDs), virtual memory, graphics memory, optical discs, network attached storage (NAS), cloud storage, tape storage, etc.

At least one embodiment of the disclosure can be described in view of the following clauses:

1. A computer-implemented method, comprising:
receiving software application metadata corresponding to a plurality of software applications installed throughout a distributed computing infrastructure;
receiving a function indicative of a mapping of related software applications of the plurality of software applications;
receiving, from a plurality of data sources in the distributed computing infrastructure, resource usage data corresponding to the plurality of software applications;
transforming a plurality of different data formats of the resource usage data into normalized data in a standardized format;
consolidating the normalized data into a unified data source using the mapping and the software application metadata;
receiving, from a graphical user interface (GUI) dashboard, a request to transform at least a portion of the normalized data according to one or more data points;
obtaining, from the request or from metadata associated with a target entity, information identifying the target entity;
determining, based at least in part on metadata corresponding to the target entity, at least one of:
   the portion of the normalized data,
   a modified version of the portion,
   a displayed insight object generated from the portion, or
   a recommendation object generated from the portion; and
in response to the request:
   transforming at least the portion of the normalized data into transformed data; and
   sending the transformed data for display at the GUI dashboard; and
providing, to a computing device associated with the target entity, at least one of the portion, the modified version of the portion, the displayed insight object, or the recommendation object.

2. The computer-implemented method of clause 1, wherein the request is obtained via a conversational interface corresponding to an artificial intelligence agent that presents one or more prompts enabling a first entity to request routing of the displayed insight object to the target entity.

3. The computer-implemented method of any of clauses 1-2, wherein the metadata corresponding to the target entity comprises one or more of a role, title, organizational responsibility, geography, preference, threshold, watchlist, priority, historical interaction, workflow responsibility, delegated authority, or other profile information associated with the target entity.

4. The computer-implemented method of any of clauses 1-3, wherein determining the displayed insight object comprises ranking a plurality of displayed insight objects according to a priority profile associated with the target entity.

5. A system, comprising:
one or more processors; and
one or more non-transitory, computer-readable media comprising executable instructions recorded thereon that, as a result of execution by the one or more processors, cause the system to at least:
   obtain one or more configurations associated with a plurality of software applications within a distributed computing infrastructure;
   receive, from a plurality of data sources in the distributed computing infrastructure, first resource data associated with the plurality of software applications;
   generate second resource data in a standardized format from different data formats of the first resource data;
   integrate the second resource data into a data source using the one or more configurations;
   receive an indication of one or more data points corresponding to the second resource data;
   obtain information identifying a target entity from the indication or from metadata associated with the target entity;
   determine, based at least in part on metadata corresponding to the target entity, at least one of:
      a portion of the second resource data,
      a modified version of the portion,
      a displayed insight object generated from the portion, or
      a recommendation object generated from the portion; and
   provide at least one of the portion, the modified version of the portion, the displayed insight object, or the recommendation object to a computing device associated with the target entity.

6. The system of clause 5, wherein the system obtains the indication of the one or more data points via a conversational interface corresponding to an artificial intelligence agent that presents a query identifying one or more insight objects relevant to the target entity.

7. The system of any of clauses 5-6, wherein the metadata corresponding to the target entity comprises one or more of role information, organizational hierarchy information, delegated authority information, threshold subscriptions, historical interaction data, or workflow responsibilities associated with the target entity.

8. The system of any of clauses 5-7, wherein the system determines the displayed insight object by ranking a plurality of displayed insight objects according to a priority profile associated with the target entity.

9. The system of any of clauses 5-8, wherein the system generates the recommendation object by summarizing the displayed insight object and identifying a proposed action responsive to a detected condition represented by the displayed insight object.

10. The system of any of clauses 5-9, wherein the recommendation object comprises a notification identifying a projected condition, forecast event, threshold breach, anomaly, imbalance, or upcoming obligation detected from the second resource data.

11. The system of any of clauses 5-10, wherein the system associates the displayed insight object or recommendation object with provenance metadata identifying an originating entity, an endorsing entity, a time, a source interface, or an “on behalf of” designation.

12. The system of any of clauses 5-11, wherein the system associates the displayed insight object or recommendation object with one or more workflow states comprising suggested, selected, awaiting confirmation, sent, delivered, viewed, acknowledged, completed, dismissed, or acted upon.

13. One or more non-transitory computer-readable storage media having stored thereon computer-executable instructions that, as a result of being executed by one or more processors of a computer system, cause the computer system to at least:
obtain software application metadata corresponding to a plurality of software applications installed throughout a distributed computing infrastructure;
obtain one or more configurations of related software applications of the plurality of software applications;
obtain, from a plurality of data sources in the distributed computing infrastructure, resource data corresponding to the plurality of software applications;
transform a plurality of different data formats of the resource data into additional data in a standardized format;
integrate the additional data into a unified data source using the one or more configurations;
obtain a request to transform one or more portions of the additional data;
obtain information identifying a target entity from the request or from metadata associated with the target entity;
determine, based at least in part on metadata corresponding to the target entity, at least one of:
   a portion of the additional data,
   a modified version of the portion,
   a displayed insight object generated from the portion, or
   a recommendation object generated from the portion; and
provide at least one of the portion, the modified version of the portion, the displayed insight object, or the recommendation object to a computing device associated with the target entity.

14. The one or more non-transitory computer-readable storage media of clause 13, wherein the request is obtained via a conversational interface associated with an artificial intelligence agent that presents one or more prompts enabling routing of the displayed insight object to the target entity.

15. The one or more non-transitory computer-readable storage media of any of clauses 13-14, wherein the metadata corresponding to the target entity comprises one or more of a role, title, organizational responsibility, organizational hierarchy information, geography, threshold subscriptions, workflow responsibility, delegated authority, historical interaction data, or workflow responsibilities associated with the target entity.

16. The one or more non-transitory computer-readable storage media of any of clauses 13-15, wherein determining the displayed insight object comprises ranking a plurality of displayed insight objects according to a priority profile associated with the target entity.

17. The one or more non-transitory computer-readable storage media of any of clauses 13-16, wherein the recommendation object comprises a summary generated from the displayed insight object and identifying a proposed action responsive to a detected condition.

18. The one or more non-transitory computer-readable storage media of any of clauses 13-17, wherein the recommendation object identifies a projected condition, forecast event, threshold breach, anomaly, imbalance, or upcoming obligation determined from the additional data.

19. The one or more non-transitory computer-readable storage media of any of clauses 13-18, wherein the computer system associates the displayed insight object or recommendation object with provenance metadata identifying an originating entity, an endorsing entity, a time, a source interface, or an “on behalf of” designation.

20. The one or more non-transitory computer-readable storage media of any of clauses 13-19, wherein the computer system associates the displayed insight object or recommendation object with one or more workflow states comprising suggested, selected, awaiting confirmation, sent, delivered, viewed, acknowledged, completed, dismissed, or acted upon.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Any system or apparatus feature as described herein may also be provided as a method feature, and vice versa. System and/or apparatus aspects described functionally (including means plus function features) may be expressed alternatively in terms of their corresponding structure, such as a suitably programmed processor and associated memory. It should also be appreciated that particular combinations of the various features described and defined in any aspects of the present disclosure can be implemented and/or supplied and/or used independently.

Any system or apparatus feature as described herein can include computer programs and computer program products comprising software code adapted, when executed on a data processing apparatus, to perform any of the methods and/or for embodying any of the apparatus and system features described herein, including any or all of the component steps of any method. Any system or apparatus feature as described herein can also include a computer or computing system (including networked or distributed systems) having an operating system that supports a computer program for carrying out any of the methods described herein and/or for embodying any of the apparatus or system features described herein. Any system or apparatus feature as described herein can also include a computer-readable media having stored thereon any one or more of the computer programs aforesaid. Any system or apparatus feature as described herein can include a signal carrying any one or more of the computer programs aforesaid.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method, comprising:
receiving software application metadata corresponding to a plurality of software applications installed throughout a distributed computing infrastructure;
receiving a function indicative of a mapping of related software applications of the plurality of software applications;
receiving, from a plurality of data sources in the distributed computing infrastructure, resource usage data corresponding to the plurality of software applications;
transforming a plurality of different data formats of the resource usage data into normalized data in a standardized format;
consolidating the normalized data into a unified data source using the mapping and the software application metadata;
receiving, from a graphical user interface (GUI) dashboard, a request to transform at least a portion of the normalized data according to one or more data points;
obtaining, from the request or from metadata associated with a target entity, information identifying the target entity;
determining, based at least in part on metadata corresponding to the target entity, at least one of:
the portion of the normalized data,
a modified version of the portion,
a displayed insight object generated from the portion, or
a recommendation object generated from the portion; and
in response to the request:
transforming at least the portion of the normalized data into transformed data; and
sending the transformed data for display at the GUI dashboard; and
providing, to a computing device associated with the target entity, at least one of the portion, the modified version of the portion, the displayed insight object, or the recommendation object.

2. The computer-implemented method of claim 1, wherein the request is obtained via a conversational interface corresponding to an artificial intelligence agent that presents one or more prompts enabling a first entity to request routing of the displayed insight object to the target entity.

3. The computer-implemented method of claim 1, wherein the metadata corresponding to the target entity comprises one or more of a role, title, organizational responsibility, geography, preference, threshold, watchlist, priority, historical interaction, workflow responsibility, delegated authority, or other profile information associated with the target entity.

4. The computer-implemented method of claim 1, wherein determining the displayed insight object comprises ranking a plurality of displayed insight objects according to a priority profile associated with the target entity.

5. A system, comprising:
one or more processors; and
one or more non-transitory, computer-readable media comprising executable instructions recorded thereon that, as a result of execution by the one or more processors, cause the system to at least:
obtain one or more configurations associated with a plurality of software applications within a distributed computing infrastructure;
receive, from a plurality of data sources in the distributed computing infrastructure, first resource data associated with the plurality of software applications;
generate second resource data in a standardized format from different data formats of the first resource data;
integrate the second resource data into a data source using the one or more configurations;
receive, an indication of one or more data points corresponding to the second resource data;
obtain information identifying a target entity from the indication or from metadata associated with the target entity;
determine, based at least in part on metadata corresponding to the target entity, at least one of:
a portion of the second resource data,
a modified version of the portion,
a displayed insight object generated from the portion, or
a recommendation object generated from the portion; and
provide at least one of the portion, the modified version of the portion, the displayed insight object, or the recommendation object to a computing device associated with the target entity.

6. The system of claim 5, wherein the system obtains the indication of the one or more data points via a conversational interface corresponding to an artificial intelligence agent that presents a query identifying one or more insight objects relevant to the target entity.

7. The system of claim 5, wherein the metadata corresponding to the target entity comprises one or more of role information, organizational hierarchy information, delegated authority information, threshold subscriptions, historical interaction data, or workflow responsibilities associated with the target entity.

8. The system of claim 5, wherein the system determines the displayed insight object by ranking a plurality of displayed insight objects according to a priority profile associated with the target entity.

9. The system of claim 5, wherein the system generates the recommendation object by summarizing the displayed insight object and identifying a proposed action responsive to a detected condition represented by the displayed insight object.

10. The system of claim 5, wherein the recommendation object comprises a notification identifying a projected condition, forecast event, threshold breach, anomaly, imbalance, or upcoming obligation detected from the second resource data.

11. The system of claim 5, wherein the system associates the displayed insight object or recommendation object with provenance metadata identifying an originating entity, an endorsing entity, a time, a source interface, or an “on behalf of” designation.

12. The system of claim 5, wherein the system associates the displayed insight object or recommendation object with one or more workflow states comprising suggested, selected, awaiting confirmation, sent, delivered, viewed, acknowledged, completed, dismissed, or acted upon.

13. One or more non-transitory computer-readable storage media having stored thereon computer-executable instructions that, as a result of being executed by one or more processors of a computer system, cause the computer system to at least:
obtain software application metadata corresponding to a plurality of software applications installed throughout a distributed computing infrastructure;
obtain one or more configurations of related software applications of the plurality of software applications;
obtain, from a plurality of data sources in the distributed computing infrastructure, resource data corresponding to the plurality of software applications;
transform a plurality of different data formats of the resource data into additional data in a standardized format;
integrate the additional data into a unified data source using the one or more configurations;
obtain a request to transform one or more portions of the additional data;
obtain information identifying a target entity from the request or from metadata associated with the target entity;
determine, based at least in part on metadata corresponding to the target entity, at least one of:
a portion of the additional data,
a modified version of the portion,
a displayed insight object generated from the portion, or
a recommendation object generated from the portion; and
provide at least one of the portion, the modified version of the portion, the displayed insight object, or the recommendation object to a computing device associated with the target entity.

14. The one or more non-transitory computer-readable storage media of claim 13, wherein the request is obtained via a conversational interface associated with an artificial intelligence agent that presents one or more prompts enabling routing of the displayed insight object to the target entity.

15. The one or more non-transitory computer-readable storage media of claim 13, wherein the metadata corresponding to the target entity comprises one or more of a role, title, organization responsibility, organizational hierarchy information, geography, threshold subscriptions, workflow responsibility, delegated authority, permissions, historical interaction data, or workflow responsibilities associated with the target entity.

16. The one or more non-transitory computer-readable storage media of claim 13, wherein determining the displayed insight object comprises ranking a plurality of displayed insight objects according to a priority profile associated with the target entity.

17. The one or more non-transitory computer-readable storage media of claim 13, wherein the recommendation object comprises a summary generated from the displayed insight object and identifying a proposed action responsive to a detected condition.

18. The one or more non-transitory computer-readable storage media of claim 13, wherein the recommendation object identifies a projected condition, forecast event, threshold breach, anomaly, imbalance, or upcoming obligation determined from the additional data.

19. The one or more non-transitory computer-readable storage media of claim 13, wherein the computer system associates the displayed insight object or recommendation object with provenance metadata identifying an originating entity, an endorsing entity, a time, a source interface, or an “on behalf of” designation.

20. The one or more non-transitory computer-readable storage media of claim 13, wherein the computer system associates the displayed insight object or recommendation object with one or more workflow states comprising suggested, selected, awaiting confirmation, sent, delivered, viewed, acknowledged, completed, dismissed, or acted upon.
